(19) United States
(12) Patent Application Publication
(10) Pub. No.: US 2026/0291969 A1
(43) Pub. Date: Sep. 24, 2026

(54) SYSTEMS AND METHODS FOR REAL TIME NETWORKED COMMUNICATION MONITORING, REMEDIATION, AND ALERTING USING GENERATIVE TECHNOLOGIES

(71) Applicant: BANK OF AMERICA CORPORATION, Charlotte, NC (US)

(72) Inventors: Chitra Muthumani, Mumbai (IN); John Bilton Kommu, Secunderabad (IN); Rakesh Madanlal Shah, Mumbai (IN); Rahul Uniyal, Dehradun (IN)

(73) Assignee: BANK OF AMERICA CORPORATION, Charlotte, NC (US)

(21) Appl. No.: 19/088,294

(22) Filed: Mar. 24, 2025

(51) Int. Cl. H04L 9/40; H04W 24/02

(52) U.S. Cl. CPC H04L 63/1425; H04W 24/02

(57) ABSTRACT

Systems, computer program products, and methods are described herein for real time networked communication monitoring, remediation, and alerting using generative technologies. The present disclosure is configured to initiate a communication linkage with one or more network communication channels, and compile and extract one or more network communication transmissions associated with a network anomaly from the one or more network communication channels. In addition, the present disclosure is configured to execute, using an artificial intelligence (AI) engine, a network transmission enrichment protocol based on the one or more network communication transmissions; and extract, using the AI engine, network communication data based on the network transmission enrichment protocol. The present disclosure is also configured to map, using the AI engine, the network communication data to a reference network communication matrix; and initiate, using the AI engine, one or more network anomalies remediations associated with the network anomaly.

### TECHNOLOGICAL FIELD

Example embodiments of the present disclosure relate to real time networked communication monitoring, remediation, and alerting using generative technologies.

Network environment continuity in electronic environments is critical for efficient, scalable, and consistent performance of network devices, applications, databases, servers, and the like that operate within a network environment. When a network anomaly is detected, such as when an outage occurs in the network environment or a security incident is discovered, expedient anomaly remediation is critical for maintaining network environment performance, data security, and network access controls. While anomaly remediation is in-process, monitoring networked communications is key for identifying a root cause of the network anomaly, determining a resolution to remediate the network anomaly, and transmitting communications associated with the resolution to inform how to prevent and mitigate future anomalies. However, securely monitoring network communications, evaluating these network communications, and translating such communications is error-prone, time-consuming, complex, and diverts resources from remediating the network anomaly.

Applicant has identified a number of deficiencies and problems associated with real time networked communication monitoring, remediation, and alerting using generative technologies. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for real time networked communication monitoring, remediation, and alerting using generative technologies.

In one aspect, a system for real time networked communication monitoring, remediation, and alerting using generative technologies is provided. In some embodiments, the system may comprise a memory device with computer-readable program code stored thereon; at least one processing device, wherein executing the computer-readable program code is configured to cause the at least one processing device to execute the computer-readable program code to: initiate a communication linkage with one or more network communication channels; compile and extract one or more network communication transmissions associated with a network anomaly from the one or more network communication channels; execute, using an artificial intelligence (AI) engine, a network transmission enrichment protocol based on the one or more network communication transmissions; extract, using the AI engine, network communication data based on the network transmission enrichment protocol; map, using the AI engine, the network communication data to a reference network communication matrix; and initiate, using the AI engine, one or more network anomalies remediations associated with the network anomaly.

In some embodiments, executing the computer-readable program code is further configured to cause the at least one processing device to: monitor, via a robotic process automation (RPA) bot, the one or more network communication channels for a device communication linkage; compile, using the RPA bot, audio data via the device communication linkage; detect, using the RPA bot, at least one disrupted device communication linkage associated with the one or more network communication channels; establish, using the RPA bot, a new device communication linkage; confirm, using the RPA bot, successful connection between the new communication linkage and the one or more network communication channels; and transmit the audio data via the new communication linkage.

In some embodiments, executing the computer-readable program code is further configured to cause the at least one processing device to: query one or more repositories based on the network communication data and retrieve and store query results; access and retrieve the reference network communication matrix; and generate, using the AI engine, a network communication transmission template based on the reference network communication matrix and the query results, wherein the AI engine comprises a large language model.

In some embodiments, executing the computer-readable program code is further configured to cause the at least one processing device to: populate a network event response based on the network communication transmission template and the network communication data using the AI engine, wherein the AI engine further comprises a large action model; configure the network event response based on a network event response criteria set; and validate the network event response using at least one of the AI engine and a device associated with a user.

In some embodiments, executing the computer-readable program code is further configured to cause the at least one processing device to: receive one or more network event response requests from one or more requestors and extract request data; determine, using the AI engine, that the network event response satisfies the one or more network event response requests; and retrieve and transmit the network event response to the one or more requestors based on the request data.

In some embodiments, executing the computer-readable program code is further configured to cause the at least one processing device to: determine the network event response fails to satisfy a threshold associated with the one or more network event response requests; authenticate one or more network devices associated with the one or more requestors; and connect the one or more network devices to the one or more network communication channels via the communication linkage.

In some embodiments, the network transmission enrichment protocol comprises: accessing and evaluating, using the AI engine, the one or more network communication transmissions to determine communication transmission attributes, wherein the AI engine further comprises a convolutional neural network; converting the one or more network communication transmissions to an alternate data type; and extracting, using the AI engine, metadata associated with the one or more network communication transmissions based on the alternate data type.

In some embodiments, executing the computer-readable program code is further configured to cause the at least one processing device to: determine, using the AI engine, one or more missing criteria from one or more systems of record; determine and execute one or more authentication methods to connect to the communication linkage; and receive the one or more missing criteria via the communication linkage.

In some embodiments, the one or more network anomalies remediations comprise: receiving, using the communication linkage, one or more responsive actions to remediate the network anomaly and impacted artifacts, wherein the impacted artifacts comprise at least one of an application, server, database, or one or more end users; generating, using the AI engine, a description associated with the one or more responsive actions; transmitting, using the communication linkage, the one or more responsive actions to one or more predetermined network devices; and transmitting the one or more responsive actions to an internal remediation repository.

In some embodiments, executing the computer-readable program code is further configured to cause the at least one processing device to: generate a user interface on a display; render one or more interactive interface elements within the user interface, wherein the one or more interactive interface elements within the user interface are associated with the network anomaly and one or more network anomaly remediations; and receive control signals from at least one device to modify the one or more interactive interface elements.

In some embodiments, executing the computer-readable program code is further configured to cause the at least one processing device to: receive at least one historical dataset; train the AI engine based on the at least one historical dataset; receive network event anomaly data; update the at least one historical dataset with the network event anomaly data; and retrain the AI engine based on the network event anomaly data.

In another aspect, a computer program product for real time networked communication monitoring, remediation, and alerting using generative technologies is provided, wherein the computer program product comprises at least one non-transitory computer-readable medium having computer-readable program code portion embodied therein, the computer-readable program code portions which when executed by a processing device are configured to cause a processor to: initiate a communication linkage with one or more network communication channels; compile and extract one or more network communication transmissions associated with a network anomaly from the one or more network communication channels; execute, using an AI engine, a network transmission enrichment protocol based on the one or more network communication transmissions; extract, using the AI engine, network communication data based on the network transmission enrichment protocol; map, using the AI engine, the network communication data to a reference network communication matrix; and initiate, using the AI engine, one or more network anomalies remediations associated with the network anomaly.

In some embodiments, the processing device is further configured to: monitor, via a robotic process automation (RPA) bot, the one or more network communication channels for a device communication linkage; compile, using the RPA bot, audio data via the device communication linkage; detect, using the RPA bot, at least one disrupted device communication linkage associated with the one or more network communication channels; establish, using the RPA bot, a new device communication linkage; confirm, using the RPA bot, successful connection between the new communication linkage and the one or more network communication channels; and transmit the audio data via the new communication linkage.

In some embodiments, the processing device is further configured to: query one or more repositories based on the network communication data and retrieve and store query results; access and retrieve the reference network communication matrix; and generate, using the AI engine, a network communication transmission template based on the reference network communication matrix and the query results, wherein the AI engine comprises a large language model.

In some embodiments, the network transmission enrichment protocol comprises: accessing and evaluating, using the AI engine, the one or more network communication transmissions to determine communication transmission attributes, wherein the AI engine further comprises a convolutional neural network; converting the one or more network communication transmissions to an alternate data type; and extracting, using the AI engine, metadata associated with the one or more network communication transmissions based on the alternate data type.

In another aspect, a computer-implemented method for real time networked communication monitoring, remediation, and alerting using generative technologies: initiating a communication linkage with one or more network communication channels; compiling and extracting one or more network communication transmissions associated with a network anomaly from the one or more network communication channels; executing, using an AI engine, a network transmission enrichment protocol based on the one or more network communication transmissions; extracting, using the AI engine, network communication data based on the network transmission enrichment protocol; mapping, using the AI engine, the network communication data to a reference network communication matrix; and initiating, using the AI engine, one or more network anomalies remediations associated with the network anomaly.

In some embodiments, the computer-implemented method is further configured for: monitoring, via a RPA bot, the one or more network communication channels for a device communication linkage; compiling, using the RPA bot, audio data via the device communication linkage; detecting, using the RPA bot, at least one disrupted device communication linkage associated with the one or more network communication channels; establishing, using the RPA bot, a new device communication linkage; confirming, using the RPA bot, successful connection between the new communication linkage and the one or more network communication channels; and transmitting the audio data via the new communication linkage.

In some embodiments, the computer-implemented method is further configured for: querying one or more repositories based on the network communication data and retrieving and storing query results; accessing and retrieving the reference network communication matrix; and generating, using the AI engine, a network communication transmission template based on the reference network communication matrix and the query results, wherein the AI engine comprises a large language model.

In some embodiments, executing the computer-readable program code is further configured to cause the at least one processing device to: determine the network event response fails to satisfy a threshold associated with the one or more network event response requests; authenticate one or more network devices associated with the one or more requestors; and connect the one or more network devices to the one or more network communication channels via the communication linkage.

In some embodiments, the computer-implemented method is further configured for: determining, using the AI engine, one or more missing criteria from one or more systems of record; determining and executing one or more authentication methods to connect to the communication linkage; and receiving the one or more missing criteria via the communication linkage.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrate technical components of an exemplary distributed computing environment for real time networked communication monitoring, remediation, and alerting using generative technologies, in accordance with an embodiment of the disclosure;

FIG. 2 illustrates an exemplary AI engine subsystem architecture, in accordance with an embodiment of the disclosure;

FIG. 3 illustrates an exemplary generative AI engine subsystem architecture, in accordance with an embodiment of the disclosure;

FIG. 4 illustrates a process flow for real time networked communication monitoring, remediation, and alerting using generative technologies, in accordance with an embodiment of the disclosure, in accordance with an embodiment of the disclosure;

FIG. 5 illustrates a process flow for monitoring one or more network communication channels using an RPA bot, in accordance with an embodiment of the disclosure;

FIG. 6 illustrates a process flow for generating a network communication transmission template, in accordance with an embodiment of the disclosure;

FIG. 7 illustrates a process flow for populating and validating a network event response, in accordance with an embodiment of the disclosure;

FIG. 8 illustrates a process flow for evaluating and transmitting the network event response based on one or more network event response requests, in accordance with an embodiment of the disclosure;

FIG. 9 illustrates a process flow for connecting one or more network devices based on a threshold determination, in accordance with an embodiment of the disclosure;

FIG. 10 illustrates a process flow for receiving one or more missing criteria, in accordance with an embodiment of the disclosure;

FIG. 11 illustrates a process flow for rendering and modifying one or more interactive interface elements, in accordance with an embodiment of the disclosure; and

FIG. 12 illustrates a process flow for training and retraining the AI engine, in accordance with an embodiment of the disclosure, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, this data may be related to the people who work for the organization, its products or services, the customers, or any other aspect of the operations of the organization. As such, the entity may be any institution, group, association, financial institution, establishment, company, union, authority, or the like, employing information technology resources for processing large amounts of data.

As described herein, a “user” may be an individual associated with an entity. As such, in some embodiments, the user may be an individual having past relationships, current relationships, or potential future relationships with an entity. In some embodiments, the user may be an employee (e.g., an associate, a project manager, an IT specialist, a manager, an administrator, an internal operations analyst, or the like) of the entity or enterprises affiliated with the entity.

As described herein, a “module” may be a self-contained unit of code within an application associated with one or more groups of functions or functionality for executing one or more tasks. In some embodiments, the module may comprise a subcomponent of an application or may comprise the entirety of an application. The module may comprise a data model that establishes how to access, modify, and/or manipulate data within the module. The module may be reusable across various aspects of an application.

As used herein, a “user interface” may be a point of human-computer interaction and communication in a device that allows a user to input information, such as commands or data, into a device, or that allows the device to output information to the user. For example, the user interface may include a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that may be used to identify a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure, and positioning (e.g., distal phalanges, intermediate phalanges, proximal phalanges, and the like)), an answer to a security question, a unique intrinsic user activity (e.g., making a predefined motion with a user device), and/or the like. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources input by the plurality of users within the system. The system may further use its authentication servers to certify the identity of users of the system, such that other users may verify the identity of the certified users. In some embodiments, the entity may certify the identity of the other users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (e.g., rotationally coupled, pivotally coupled, or the like). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. For purposes of this disclosure, a resource is typically stored in a resource repository-a storage location where one or more resources are organized, stored, and retrieved electronically using a computing device.

As used herein, a “resource transfer,” “resource distribution,” or “resource allocation” may refer to any transactions, activities, or communications between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. When discussing that resource transfers or transactions are evaluated, it could mean that the transaction has already occurred, is in the process of occurring or being processed, or that the transaction has yet to be processed/posted by one or more financial institutions. In some embodiments, a resource transfer or transaction may refer to non-financial activities of the user. In this regard, the transaction may be changing a password, adding new accounts, opening new accounts, adding or modifying account parameters/restrictions, performing/modifying authentication procedures and/or credentials, modifying parameters associated with the one or more distributed network data domains, and/or the like.

Accordingly, the present disclosure is directed to real time networked communication monitoring, remediation, and alerting using generative technologies. The present disclosure is directed to detect the presence of a network anomaly and initiate a communication linkage with available network communication channels. In addition, the present disclosure is configured to compile and extract one or more network communication transmissions associated with a network anomaly from the communication channels. Utilizing an AI engine, the present disclosure is configured to execute a network transmission enrichment protocol for accessing and evaluating, using the AI engine, the one or more network communication transmissions to determine communication transmission attributes, wherein the AI engine further comprises a convolutional neural network; converting the one or more network communication transmissions to an alternate data type; and extracting, using the AI engine, metadata associated with the one or more network communication transmissions based on the alternate data type. The present disclosure also is configured to extract network communication data, map the network communication data to a reference communication matrix, and initiate an anomaly remediation associated with the network anomaly. By leveraging real time networked communication monitoring, remediation, and alerting using generative technologies, the present disclosure provides for quicker anomaly remediation times, enhancing the system continuity performance and improving security of impacted applications and devices.

What is more, the present disclosure provides a technical solution to a technical problem. As described herein, the technical problem includes real time networked communication monitoring, remediation, and alerting using generative technologies. The technical solution presented herein allows for allows for dynamic, intelligent, scalable, and efficient real time networked communication monitoring, remediation, and alerting using generative technologies. In particular, real time networked communication monitoring, remediation, and alerting using generative technologies is an improvement over existing solutions to the technical challenges, (i) with fewer steps to achieve the solution, thus reducing the amount of computing resources, such as processing resources, storage resources, network resources, and/or the like, that are being used (e.g., utilizing an AI engine to monitor network transmissions, evaluate the network transmissions, and transmit transformed network transmissions to connected network devices), (ii) providing a more accurate solution to problem, thus reducing the number of resources required to remedy any errors made due to a less accurate solution (e.g., utilizing the AI engine to generate network event responses, validating the network event responses, and determining adequacy of the network event responses), (iii) removing manual input and waste from the implementation of the solution, thus improving speed and efficiency of the process and conserving computing resources (e.g., by utilizing the AI engine serve as a centralized network communications hub via monitoring network communications, ensuring connectivity to the network communication channels, and by searching internal repositories for data associated with the network anomaly), (iv) determining an optimal amount of resources that need to be used to implement the solution, thus reducing network traffic and load on existing computing resources (e.g., by facilitating real-time network communication monitoring, analysis, and transmissions associated with remediating the detected anomaly). Furthermore, the technical solution described herein uses a rigorous, computerized process to perform specific tasks and/or activities that were not previously performed. In specific implementations, the technical solution bypasses a series of steps previously implemented, thus further conserving computing resources.

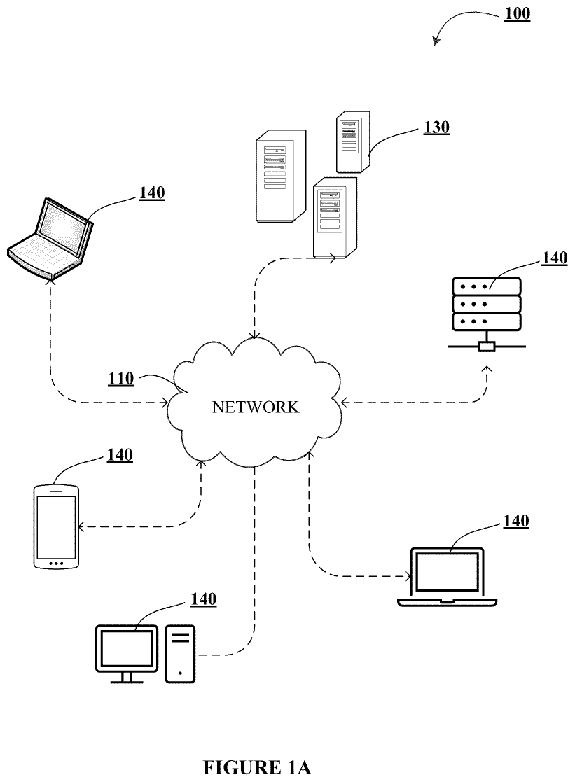

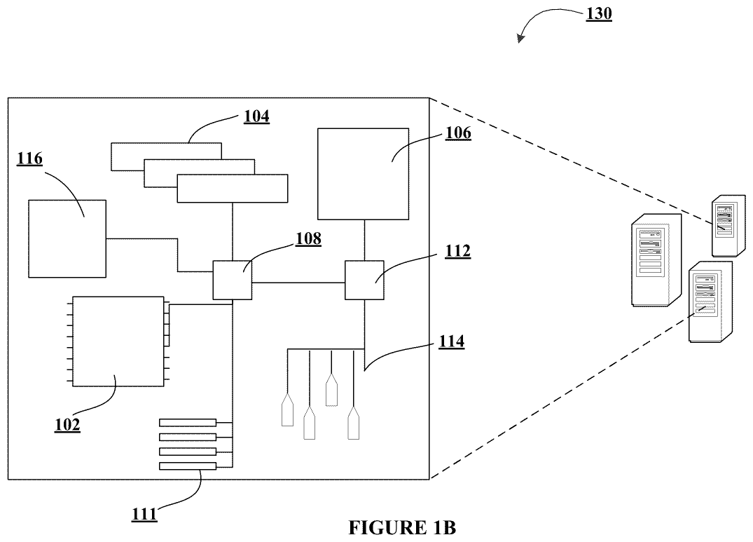

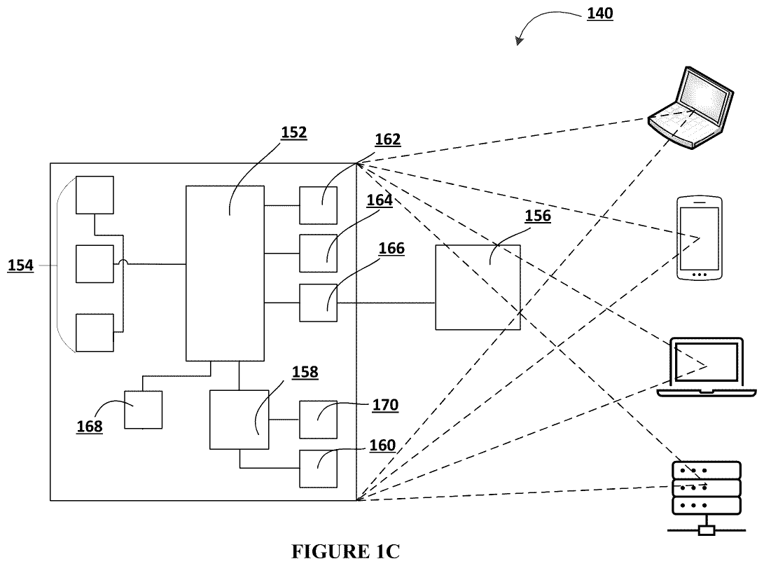

FIGS. 1A-1C illustrate technical components of an exemplary distributed computing environment for real time networked communication monitoring, remediation, and alerting using generative technologies 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connected to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which may be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 106. The system 130 may also include a high-speed interface 108 connecting to the memory 104, and a low-speed interface 112 connecting to low-speed bus 114 and storage device 106. Each of the components 102, 104, 106, 108, 112 and 114 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product may be tangibly embodied in an information carrier. The computer program product may also contain instructions that, when executed, perform one or more methods, such as those described above. The information carrier may be a non-transitory computer-or machine-readable storage medium, such as the memory 104, the storage device 106, or memory on processor 102.

The high-speed interface 108 manages bandwidth-intensive operations for the system 130, while the low-speed interface/controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, the low-speed interface/controller 112 is coupled to storage device 106 and low-speed bus/expansion port 114. The low-speed bus/expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor 152 may be implemented as a chipset of chips that include separate and multiple analog and digital processors. The processor 152 may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 166 may comprise appropriate circuitry and may be configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 may be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier may be a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through the communication interface 158, which may include digital signal processing circuitry where necessary. The communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, a GPS (Global Positioning System) receiver module 170 may provide additional navigation-and location-related wireless data to end-point device(s) 140, which may be used as appropriate by applications running thereon, and in some embodiments, one or more applications operating on the system 130.

The end-point device(s) 140 may also communicate audibly using an audio codec 162, which may receive spoken information from a user and convert the spoken information to usable digital information. The audio codec 162 may likewise generate audible sound for a user, such as through a speaker (e.g., in a handset of end-point device(s) 140). Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described herein may be realized in digital electronic circuitry, integrated circuitry, specially designed ASICs (application specific integrated circuits), computer hardware, firmware, software, and/or combinations thereof.

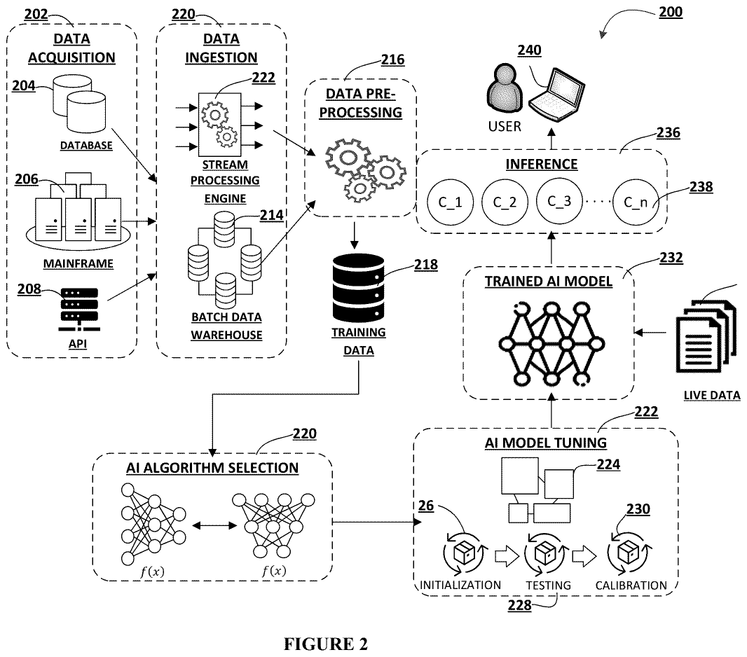

FIG. 2 illustrates an exemplary AI engine subsystem architecture 200, in accordance with an embodiment of the disclosure. The artificial intelligence subsystem 200 may include a data acquisition engine 202, data ingestion engine 210, data pre-processing engine 216, AI tuning engine 222, and inference engine 236.

The data acquisition engine 202 may identify various internal and/or external data sources to generate, test, and/or integrate new features for training the artificial intelligence model 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including Rational Database Management Systems (RDBMs), other types of databases, Simple Storage System (S3) buckets, Comma Separated Values (CSVs), or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In artificial intelligence, the quality of data and the useful information that can be derived therefrom directly affects the ability of the artificial intelligence model 224 to learn. The data pre-processing engine 216 may implement advanced integration and processing steps needed to prepare the data for artificial intelligence execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of artificial intelligence algorithm being used, this training data 218 may require further enrichment. For example, in supervised learning, the training data is enriched using one or more meaningful and informative labels to provide context so an artificial intelligence model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The AI tuning engine 222 may be used to train an artificial intelligence engine 224 using the training data 218 to make predictions or decisions without explicitly being programmed to do so. The artificial intelligence engine 224 represents what was learned by the selected artificial intelligence algorithm 220 and represents the rules, numbers, and any other algorithm-specific data structures required for classification. Selecting the right artificial intelligence algorithm may depend on a number of different factors, such as the problem statement and the kind of output needed, type and size of the data, the available computational time, number of features and observations in the data, and/or the like. Artificial intelligence algorithms may refer to programs (math and logic) that are configured to self-adjust and perform better as they are exposed to more data. To this extent, artificial intelligence algorithms are capable of adjusting their own parameters, given feedback on previous performance in making prediction about a dataset.

The artificial intelligence algorithms contemplated, described, and/or used herein include supervised learning (e.g., using logistic regression, using back propagation neural networks, using random forests, decision trees, or the like), unsupervised learning (e.g., using an Apriori algorithm, using K-means clustering), semi-supervised learning, reinforcement learning (e.g., using a Q-learning algorithm, using temporal difference learning), and/or any other suitable artificial intelligence model type. Each of these types of artificial intelligence algorithms can implement any of one or more of a regression algorithm (e.g., ordinary least squares, logistic regression, stepwise regression, multivariate adaptive regression splines, locally estimated scatterplot smoothing, or the like), an instance-based method (e.g., k-nearest neighbor, learning vector quantization, self-organizing map, or the like), a regularization method (e.g., ridge regression, least absolute shrinkage and selection operator, elastic net, or the like), a decision tree learning method (e.g., classification and regression tree, iterative dichotomiser 3, C4.5, chi-squared automatic interaction detection, decision stump, random forest, multivariate adaptive regression splines, gradient boosting machines, or the like), a Bayesian method (e.g., naïve Bayes, averaged one-dependence estimators, Bayesian belief network, or the like), a kernel method (e.g., a support vector machine, a radial basis function, or the like), a clustering method (e.g., k-means clustering, expectation maximization, or the like), an associated rule learning algorithm (e.g., an Apriori algorithm, an Eclat algorithm, or the like), an artificial neural network model (e.g., a Perceptron method, a back-propagation method, a Hopfield network method, a self-organizing map method, a learning vector quantization method, or the like), a deep learning algorithm (e.g., a restricted Boltzmann machine, a deep belief network method, a convolution network method, a stacked auto-encoder method, or the like), a dimensionality reduction method (e.g., principal component analysis, partial least squares regression, Sammon mapping, multidimensional scaling, projection pursuit, or the like), an ensemble method (e.g., boosting, bootstrapped aggregation, AdaBoost, stacked generalization, gradient boosting machine method, random forest method, or the like), and/or the like.

To tune the artificial intelligence model, the AI model tuning engine 222 may repeatedly execute cycles of experimentation 226, testing 228, and tuning 230 to optimize the performance of the artificial intelligence algorithm 220 and refine the results in preparation for deployment of those results for consumption or decision making. To this end, the AI model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained artificial intelligence model 232 is one whose hyperparameters are tuned and model accuracy maximized.

The trained artificial intelligence model 232, similar to any other software application output, can be persisted to storage, file, memory, or application, or looped back into the processing component to be reprocessed. More often, the trained artificial intelligence model 232 is deployed into an existing production environment to make practical business decisions based on live data 234. To this end, the artificial intelligence subsystem 200 uses the inference engine 236 to make such decisions. The type of decision-making may depend upon the type of artificial intelligence algorithm used. For example, artificial intelligence models trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, artificial intelligence models trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, artificial intelligence models that perform regression techniques may use live data 234 to predict or forecast continuous outcomes.

It will be understood that the embodiment of the artificial intelligence subsystem 200 illustrated in FIG. 2 is exemplary and that other embodiments may vary. As another example, in some embodiments, the artificial intelligence subsystem 200 may include more, fewer, or different components.

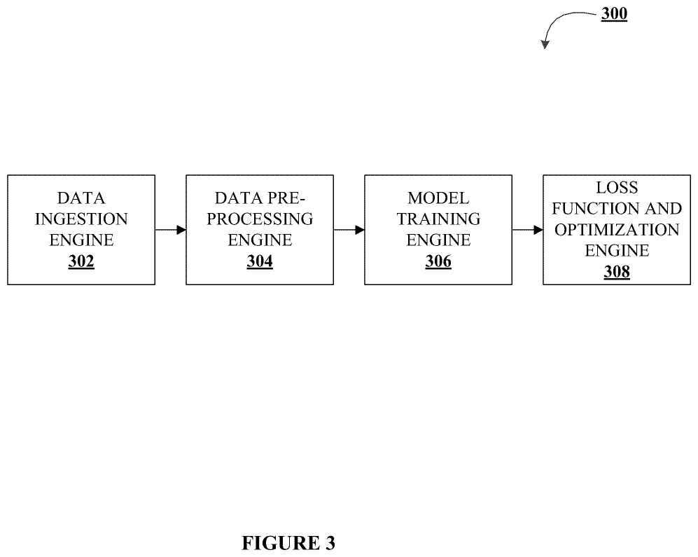

FIG. 3 illustrates an exemplary generative AI subsystem 300, in accordance with an embodiment of the invention. The generative AI subsystem 300 may include a data ingestion engine 302, a data pre-processing engine 304, and a model training engine 306. It should be understood that the generative AI subsystem 300 is merely an example, and other embodiments may include more, fewer, or different components depending on the specific requirements and implementations of the system. For instance, additional engines for data validation, feature selection, or distributed computing may be integrated into the subsystem, or certain components described herein may be consolidated or omitted based on system performance objectives. Therefore, the generative AI subsystem 300 should not be considered limiting and may be adapted to various configurations within the scope of the invention.

The data ingestion engine 302 may identify various internal and/or external data sources to generate, test, and/or integrate new features for training the generative AI model. These internal and/or external data sources (e.g., text corpora, web-based text data, document repositories, or decentralized text storage system) may be initial locations where the data originates or where physical information is first digitized. In addition to conventional data sources, the data ingestion engine 302 may support decentralized storage systems, such as blockchain-based data sources, and privacy-preserving methods such as differential privacy. The data ingestion engine 302 may identify the location of the data and describe connection characteristics for access and retrieval of data. In some embodiments, data is transported from each data source using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like.

Depending on the nature of the data, the data ingestion engine 302 may move the data to a destination for storage or further analysis. Typically, the data may be in varying formats as they come from different sources, including RDBMS, other types of databases, S3 buckets, CSVs, or from streams. For a Large Language Model (LLM), text data may originate from sources such as web scrapes, social media, large public text datasets, or the like. Since the data comes from different places, it needs to be cleansed and transformed so that it can be analyzed together with data from other sources. The data may be ingested in real-time, using stream processing, in batches using a batch data warehouse, or a combination of both. Stream processing may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse collects and transfers data in batches according to scheduled intervals, trigger events, or any other logical ordering.

In Machine Learning (ML) and/or AI, the quality of data and the useful information that can be derived therefrom directly affects the ability of the machine learning model to learn. The data pre-processing engine 304 may implement advanced integration and processing steps needed to prepare the data for machine learning execution, including tokenization, text normalization, and removal of irrelevant elements like HTML tags in web-based data, especially for LLM training. This may include modules to perform any upfront, data transformation to consolidate the data into alternate forms by changing the value, structure, or format of the data using generalization, normalization, attribute selection, and aggregation, text-specific transformations such as stemming and lemmatization, data cleaning by filling missing values, smoothing the noisy data, resolving the inconsistency, and removing outliers, and/or any other encoding steps as needed. In some embodiments, the data pre-processing engine 304 may perform real-time pre-processing at the edge via edge computing devices, allowing for the transformation and reduction of data prior to transmission to centralized locations, thereby reducing latency and conserving network bandwidth.

In addition to improving the quality of the data, the data pre-processing engine 304 may transform categorical data into numerical formats that are suitable for machine learning algorithms. In this regard, the data pre-processing engine 304 may use techniques such as one-hot encoding or label encoding depending on the nature of the categorical variables and the intended use of the data.

In some embodiments, the data pre-processing engine 304 may also include dimensionality reduction techniques, where the number of input features is reduced while retaining the most relevant information. In this regard, the data pre-processing engine 304 may include methods such as Principal Component Analysis (PCA) or apply feature selection algorithms to remove redundant or irrelevant features, thereby reducing the computational complexity of the model training phase. Feature selection may be particularly beneficial in datasets with a high number of features, ensuring that the generative AI models do not overfit to noise or irrelevant details. The pre-processed data output from the data pre-processing engine 304 may then be fed into the model training module 306.

The model training engine 306 may be responsible for training the generative AI models using the pre-processed data from the data pre-processing engine 304. The model training engine 306 may implement various machine learning algorithms, including but not limited to Generative Adversarial Networks (GANs), Variational Autoencoders (VAEs), transformers, diffusion models, or other specialized architectures depending on the specific requirements of the system. These models may be used in a broad range of applications, such as LLMs for text generation, image generation models, video synthesis models, audio generation models, and/or the like. The model training engine 306 may optimize these models by continuously adjusting their internal parameters based on the patterns and relationships identified within the data.

In some embodiments, the model training engine 306 may include a training data handler, which manages the partitioning of the pre-processed data into training, validation, and testing datasets. The training data is used to update the model's parameters, while the validation and testing datasets are reserved to evaluate the model's performance during and after training. The model training engine 306 may support various data-handling strategies, such as cross-validation or random shuffling, to ensure that the model generalizes well and is not overfitting to the training data.

In embodiments involving large language models, the model training engine 306 may utilize transformer-based architectures, such as the Transformer, Bidirectional Encoder Representations from Transformers (BERT), Generative Pre-trained Transformer (GPT), or the like. Transformer models rely on mechanisms like self-attention to capture dependencies between words in a sequence, regardless of their distance from one another. The self-attention mechanism allows the model to weigh the importance of different words in a sentence and establish complex relationships important for understanding context. During training, the model may process vast amounts of text data and learn to predict the next word or token in a sequence based on the input context. This training process allows LLMs to generate coherent text, complete sentences, translate languages, or answer questions based on learned patterns from the data.

The transformer-based LLMs may be trained using autoregressive (e.g., GPT) or masked-language modeling techniques (e.g., BERT). In autoregressive models, the training process may include predicting the next word in a sequence by progressively revealing more context to the model. The model iteratively improves its predictions based on its performance during prior iterations. Masked-language modeling involves masking certain words in a sentence and training the model to correctly predict the masked words based on surrounding context. Both approaches enable LLMs to capture intricate patterns in human language, improving their ability to manage tasks such as summarization, translation, and text generation. Loss functions like cross-entropy loss may be used to optimize the model's performance by comparing predicted tokens with the actual tokens in the dataset to guide the model to minimize prediction errors during training, as described in further detail herein.

In embodiments involving image generation models, the model training engine 306 may utilize transformer-based architectures, such as Vision Transformers (ViTs) or generative adversarial networks (GANs). Vision Transformers rely on self-attention mechanisms to process images as sequences of patches rather than whole images, allowing the model to capture spatial dependencies and patterns across the image. During training, the model may be exposed to large datasets containing diverse image types to learn features like textures, edges, and shapes. The model may then generate or reconstruct images by interpreting these patterns and applying learned spatial relationships. GAN-based models may also be used, where a generator network creates images, and a determinator network evaluates their realism, enabling the model to improve through adversarial training.

Image generation models may employ various training techniques, such as pixel-wise reconstruction or adversarial training, depending on the architecture. Pixel-wise reconstruction methods involve learning to reconstruct an image from its corrupted or downscaled version, optimizing the model to minimize the difference between the predicted and actual pixels (e.g., using mean squared error as the loss function). Adversarial training, often used with GANs, involves iteratively improving the generator network to produce images that are increasingly indistinguishable from real images, based on feedback from the determinator network. These approaches allow the model to capture complex visual features, enabling applications such as image synthesis, enhancement, and style transfer.

For video generation models, the model training engine 306 may employ transformer-based architectures like Video Transformers or GAN-based models specifically designed for handling temporal sequences. Video Transformers use self-attention mechanisms to model dependencies not only between pixels within a single frame but also across frames, allowing them to understand temporal relationships and motion patterns in videos. The model may be trained on large video datasets, enabling it to learn and reproduce dynamic changes and interactions between objects over time. GAN-based video models may incorporate spatiotemporal networks to evaluate the realism of generated video sequences, optimizing the model to produce continuous and coherent frames.

Video generation models may utilize spatial-temporal modeling techniques or adversarial training for generating realistic motion and video sequences. Spatial-temporal modeling involves learning the spatial features within each frame while simultaneously capturing the temporal dependencies between frames, optimizing the model's ability to predict future frames or complete missing sequences. Loss functions like mean squared error or perceptual loss may be applied to reduce discrepancies between predicted and actual frames. Adversarial training, on the other hand, may involve a generator creating video sequences and a determinator evaluating their realism, encouraging the generator to improve by minimizing the discrepancy identified by the determinator. These techniques may enable video generation models to create coherent and realistic sequences, useful in applications such as video synthesis and animation.

In audio generation models, the model training engine 306 may utilize architectures such as Audio Transformers or Recurrent Neural Networks (RNNs) like WaveNet, designed to manage sequential and waveform data. Audio Transformers leverage attention mechanisms to capture relationships between segments of audio, allowing them to model temporal dependencies and predict the next audio sample based on previous context. During training, the model may process large audio datasets containing diverse sound patterns to learn representations of different audio features, such as frequency, amplitude, and harmonics. This training enables the model to generate coherent audio sequences, including speech, music, or ambient sounds, by synthesizing these learned patterns.

Audio generation models may be trained using sequence modeling techniques or autoregressive methods, depending on the architecture. Sequence modeling techniques involve processing and predicting sequences of audio samples, optimizing the model to capture and reproduce temporal dependencies in sound. Autoregressive methods, such as those employed in WaveNet, focus on predicting each audio sample based on prior samples, progressively refining the generated audio sequence over multiple iterations. Loss functions like mean absolute error or cross-entropy loss may be used to minimize the error between predicted and actual audio samples, guiding the model to improve its accuracy. These approaches allow audio generation models to create continuous and realistic audio outputs, applicable in areas such as speech synthesis, music generation, and sound effect creation.

The reconstruction loss ensures that the difference between the original input and the reconstructed output is minimized, guiding the decoder to generate outputs that closely resemble the input data. The second component, KL (Kullback-Liebler) divergence loss, regularizes the latent space by ensuring that the distribution of latent variables conforms to a predefined probabilistic distribution, often a Gaussian distribution. This constraint encourages the model to learn a well-organized and smooth latent space, allowing for meaningful sampling from this space during inference. By combining these loss functions, the VAE can learn a latent space that not only captures the underlying patterns in the data but also allows for the generation of novel outputs by sampling new points from this space. During the inference phase, the trained model can sample random points from the latent space to generate new, previously unseen data instances.

In training generative AI models, the model training engine 306, which includes an optimization module 308, may implement various optimization techniques to improve model performance and efficiency. The optimization module 308 is responsible for adjusting the model's internal parameters continuously, using feedback from relevant loss functions tailored to the application (e.g., text, image, audio, or video generation). Techniques such as gradient clipping, learning rate scheduling, and mixed-precision training are applied by the optimization module 308 to stabilize and fine-tune the training process. Gradient clipping may be used to stabilize the training process, especially in transformer-based models, by capping the magnitude of gradients to prevent them from becoming excessively large. Learning rate scheduling may involve gradually increasing the learning rate during initial training phases (warm-up) and then decaying it as training progresses to fine-tune the model's parameters more effectively. Mixed-precision training, which leverages lower-precision (e.g., float16) arithmetic while retaining higher precision (e.g., float32) for specific calculations, may be used to accelerate training and reduce memory consumption, enabling the model to scale efficiently even when trained on large datasets.

In some embodiments, the model training engine 306 may implement early stopping mechanisms to prevent overfitting. Early stopping monitors the generative AI model's performance on the validation dataset, halting the training process if the performance does not improve after a specified number of iterations. This ensures that the generative AI model does not continue training on noise or irrelevant patterns, which could degrade its performance on unseen data. The model training engine 306 may also support distributed training across multiple computing nodes, allowing the system to scale its computational resources as needed. Distributed training may involve splitting the generative AI model and data across multiple machines or Graphical Processing Units (GPUs), where each node processes a portion of the data and updates the model in parallel. This is particularly useful for large datasets or models that require significant computational power, such as deep generative models. The model training engine 306 may synchronize the updates across the nodes using techniques like synchronous or asynchronous gradient descent.

Once the generative AI model is trained, the model training engine 306 may save the final trained generative AI model in a persistent storage location for future use. In specific embodiments, metadata such as the number of epochs, the final loss values, and values of learned parameters may be logged for model versioning and/or retraining at a later stage. In some embodiments, the model training engine 306 may also implement transfer learning, where a pre-trained model is fine-tuned on a smaller, domain-specific dataset. This may reduce the amount of time and data required to train a new model, especially in cases where the available data is limited or highly specialized. The model training engine 306 may adjust the parameters of the pre-trained model to better align with the new dataset, while preserving the learned features from the original training.

In embodiments involving LLMs, new output is generated by sampling from the model's probability distribution of tokens, conditioned on the context provided as input. Transformer-based architectures, such as GPT, use an auto-regressive approach where the model predicts the next token in a sequence one step at a time, using previously generated tokens as input for subsequent predictions. The process starts with a prompt or an initial sequence of words, and the model iteratively generates new tokens, forming coherent sentences or paragraphs based on the learned context and language patterns. For masked-language modeling (e.g., BERT), new output may be generated by filling in masked parts of the input sequence, allowing the model to complete sentences or generate variations of the provided text. The generated output can be controlled by adjusting parameters such as heat, which influences the randomness of the token sampling, enabling the generation of diverse or deterministic responses.

In image generation models, such as those using ViTs or GANs, new output is generated by sampling from the learned distribution in the model's latent space. For GANs, the generator network creates an image by transforming random noise vectors into structured image outputs through a series of layers that learn visual features like shapes, textures, and colors. The generated image is then refined through adversarial feedback from the determinator network, which assesses the realism of the generated output. For transformer-based image models, the process may involve reconstructing images by assembling patches based on the learned dependencies between them. Input conditions, such as prompts describing desired features or specific noise vectors, guide the generation process, allowing for the creation of customized images or variations of existing visual styles. These models may also generate images based on style transfer techniques or predefined templates, synthesizing images that align with the characteristics present in the training data.

Video generation models utilize spatiotemporal dependencies to synthesize new video sequences based on the patterns learned during training. In transformer-based architectures, the model may generate video frames sequentially, predicting the next frame based on the input frames and the temporal context established by prior frames. GAN-based models, specifically designed for video synthesis, may sample noise vectors, or use a sequence of frames as input, transforming these into continuous and temporally coherent video outputs through the generator network. The determinator evaluates the temporal consistency and realism of the output, ensuring the generated video mimics the motion dynamics and object interactions present in real-world video data. Such models may also use attention mechanisms to focus on critical elements within each frame and their evolution across time, facilitating realistic scene transitions and motion patterns. The generation process may include user-defined input such as initial frames, motion descriptions, or specific video attributes, providing control over the output.

Audio generation models, including Audio Transformers or autoregressive architectures like WaveNet, generate new audio sequences by predicting audio samples based on learned dependencies in sequential sound data. For autoregressive models, the generation process involves producing each audio sample one at a time, conditioned on previously generated samples, allowing the model to build complex audio patterns such as speech, music, or ambient sounds. The model starts with an initial segment or a random seed and uses its learned parameters to predict and synthesize subsequent samples, constructing a continuous audio waveform. Audio Transformers, on the other hand, may use attention mechanisms to identify important temporal segments within the input audio and synthesize new output based on these learned patterns. The user can control the type of audio generated by providing parameters such as pitch, tempo, or initial sound clips, enabling the model to generate outputs tailored to specific use cases like speech synthesis, music composition, or environmental sound generation.

In some embodiments, generative AI models may also integrate multiple modalities, enabling cross-modal generation where output in one modality influences or conditions the generation in another. For example, a video generation model may use text descriptions as input, synthesizing video content that aligns with the specified narrative or visual scene described. Similarly, image generation models may generate visual representations based on audio inputs, such as generating animations synchronized to musical rhythms or speech patterns. These cross-modal systems typically involve conditional GANs or multi-modal transformers, where the model processes input from one domain (e.g., text or audio) and learns to generate output in another domain (e.g., video or image) by aligning the patterns and dependencies between the different modalities. These models may allow users to generate complex, multimodal content based on combinations of inputs, such as using textual prompts to control the visual and auditory elements of a video.

It will be understood that the embodiment of the generative AI subsystem 300 illustrated in FIG. 3 is exemplary and that other embodiments may vary. The generative AI subsystem 300, as well as its constituent elements, may vary, and modifications or alternative configurations may be implemented without departing from the broader scope of the invention. For instance, different machine learning algorithms, data sources, optimization techniques, or training methodologies may be employed depending on system requirements, application domain, and available computational resources. Furthermore, features and functionalities described in one embodiment may be combined with those of another embodiment as needed, and vice versa.

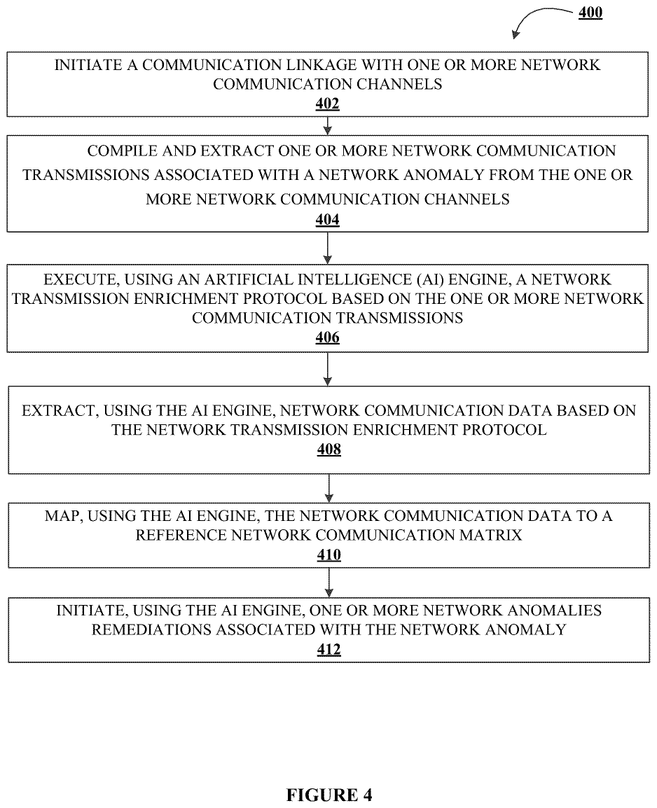

FIG. 4 illustrates a process flow 400 for real time networked communication monitoring, remediation, and alerting using generative technologies, in accordance with an embodiment of the disclosure. In some embodiments, a system (e.g., similar to one or more of the systems described herein with respect to FIGS. 1A-1C) may perform one or more of the steps of process flow 400. For example, a real time networked communication monitoring, remediation, and alerting using generative technologies system (e.g., the system 130 described herein with respect to FIGS. 1A-1C) may perform the steps of process flow 400. In some embodiments, an AI engine (e.g., such as the AI engine like that described in FIG. 2) or a generative AI subsystem (e.g., such as the generative AI subsystem described in FIG. 3) may perform some or all of the steps described in process flow 400.

As shown in block 402, the process flow 400 may include the step of initiating a communication linkage with one or more network communication channels. In some embodiments, the system executes an authentication prior to initiating the communication linkage with one or more network communication channels to validate that only authorized devices establish the communication linkage with one or more network communication channels, which may ensure the security of the electronic environment, prevent unauthorized access from a malicious actor, and/or protect sensitive data (e.g., proprietary technical configurations, personally identifying data stored in a database, and/or confidential data for internal use). The authentication may comprise one or more authentication methods (e.g., authentication credentials, digital certificates, centralized authentication server, ticket-based protocol, token-based authentication, multi-factor, single sign-on, authentication application, Remote Authentication Dial-In User Service protocol, Open Authorization protocol, OpenID Connect, and/or the like), each of which may selected dynamically by the AI engine based on the one or more network communication channels.

In some embodiments, the initiation of a communication linkage with the one or more network communication channels may be prompted by detection of an anomaly. In some embodiments, the anomaly may be detected by a executing a scan of a network, deployment environment, electronic environment, and/or the like. The anomaly may be detected by the system, AI engine, and/or a network device may detect the anomaly and trigger an alert for initiating the communication linkage. When an alert triggers the initiation of the communication linkage, the system may receive the alert and in response, may trigger initiating the communication linkage.

In some embodiments, the network anomaly may comprise an error in a deployment environment, information technology system outage, offline application, corrupted database, database error, applications operating with one or more reduced functions, offline servers, corrupted databases, comprised databases, corrupted applications, deleted files, corrupted files, misappropriated data, breached repository comprising personally identifying data, out of date software, missing critical security patches, lack of network access by users, abnormal network traffic patterns, anomalous spike in network traffic through a network port, network data packets comprising malware, abnormal failed authentication attempts, a coding error in one or more software code files, malicious code in one more software code files, unauthorized and/or unauthenticated network device, unresponsive application and/or module, incompatible operating system, version of code and/or module and/or application that is no longer supported internally and/or via an external vendor, privacy settings below a privacy threshold, data security settings below a security threshold, access controls below an access security threshold, and/or the like. and/or the like.

The communication linkage may comprise an encrypted network transmission channel, secure socket layer (SSL), TCP/IP, network interface between one or more devices, and/or connected network communication pathway comprising nodes and edges. In some embodiments, the system may transmit test network transmissions to ensure successful communication linkage with the one or more network communication channels. According to some embodiments, the one or more network communication channels may comprise at least one network communication modality, including, without limitation, network data packet transmissions, text, email, voice calls, web calls, conference calls, video calls, voice-over-IP communications, instant message, digital chat messaging platforms, and/or the like.

As shown in block 404, the process flow 400 may include the step of compiling and extracting one or more network communication transmissions associated with a network anomaly from the one or more network communication channels. In some embodiments, the system monitors continuous network communication transmissions transmitted via the one or more communication channels. During this monitoring, the system may determine to compile and extract network communication transmissions associated with the network anomaly, wherein the network communication transmissions associated with the network anomaly may comprise a network anomaly root cause, network anomaly identification, network anomaly description, impacts caused by the network anomaly (e.g., applications operating with one or more reduced functions, offline servers, corrupted databases, comprised databases, corrupted applications, deleted files, corrupted files, misappropriated data, breached personally identifying data, out of date software, missing critical security patches, malicious code, lack of network access by users, and/or the like).

According to some embodiments, extracting one or more network communication transmissions associated with a network anomaly from the one or more network communication channels may comprise detecting target data (such as data associated with network anomaly root causes, impacts of the network anomaly, and/or remediation of the network anomaly) transmitted in the one or more network communication transmissions, creating a duplication of the one or more network communication transmissions, and/or storing the duplication in a repository.

As shown in block 406, the process flow 400 may include the step of executing, using an AI engine, a network transmission enrichment protocol based on the one or more network communication transmissions. In some embodiments, the network transmission enrichment protocol may comprise accessing and evaluating, using the AI engine, the one or more network communication transmissions to determine communication transmission attributes, wherein the AI engine further comprises a convolutional neural network. A natural language processing algorithm may be utilized by the AI engine for parsing and evaluating the one or more network communication transmissions, according to some embodiments.

The one or more network communication transmissions may comprise real-time verbal communication and/or text data transmitted via the one or more communication channels, wherein the one or more network communication transmissions may comprise structured and/or unstructured data. By way of non-limiting example, and in some embodiments, the one or more network communication transmissions may comprise raw waveform data, which may be accessed and/or stored by the system. In some embodiments, the raw waveform data may be evaluated via a Mel spectrogram, wherein signals associated with audio data may be converted to a spectrogram, a frequency axis may be mapped to the mel scale, and/or a resultant visual representation may be generated.

According to some embodiments, the communication transmission attributes may comprise latest speech representations (e.g., high-level verbal data models) associated with the one or more network communication transmissions. The communication transmission attributes may comprise criteria associated with communication data, such as a intonation (such as rising and/or falling intonation) associated with a communication transmission, duration of a communication transmission, pitch associated with a communication transmission (such as verbal and/or audio data), speech type associated with a communication transmission (such as factual, humorous, enthusiasm, concern, confusion, and/or the like), and/or length of individual words used during a communication transmission, according to some embodiments.

In some embodiments, the network transmission enrichment protocol may comprise converting the one or more network communication transmissions to an alternate data type. In some embodiments, the each of the one or more network communication transmissions may be converted to an alternate data type simultaneously, via batch processing at set intervals, and/or via dynamic request to trigger a conversion. By way of non-limiting example, and in some embodiments, converting the one or more network communication transmissions to an alternate data type may comprise converting text data to audio data, and/or may comprise converting audio data to text data.

According to some embodiments, the network transmission enrichment protocol may comprise extracting, using the AI engine, metadata associated with the one or more network communication transmissions based on the alternate data type. In some embodiments, the metadata may comprise an identifier associated with end users, a descriptor associated with the alternate data type, one or more network devices associated with the one or more network communication transmissions, end users impacted by the network anomaly, one or more recipient lists impacted by the network anomaly, entity groups associated with the network anomaly, failed system actions associated with end users, and/or the like.

According to some embodiments, the network transmission enrichment protocol may comprise at least one of accessing and evaluating, using the AI engine, the one or more network communication transmissions to determine communication transmission attributes, wherein the AI engine further comprises a convolutional neural network; converting the one or more network communication transmissions to an alternate data type; and/or extracting, using the AI engine, metadata associated with the one or more network communication transmissions based on the alternate data type.

As shown in block 408, the process flow 400 may include the step of extracting, using the AI engine, network communication data based on the network transmission enrichment protocol. In some embodiments, extracting network communication data based on the network transmission enrichment protocol may comprise the AI engine determining which network communication data to extract. For example, the AI engine may utilize the communication transmission attributes to determine what network communication data to extract. In some embodiments, the AI engine may extract all network communication data. The network communication data may be extracted, stored in an extraction repository, and/or processed. Processing the extracted network communication data may comprise obfuscation, encryption, and/or data cleansing. The AI engine may execute the extraction continuously, via set schedules, and/or upon on-demand request.

As shown in block 410, the process flow 400 may include the step of mapping, using the AI engine, the network communication data to a reference network communication matrix. In some embodiments, the AI engine may map the network communication data to a reference network communication matrix, which may comprise a reference table. The reference table may comprise a description of the network anomaly, one or more network accounts associated with the AI engine (e.g., accounts utilized by the AI engine to access databases, servers, network devices, systems of record, user configurations, applications, modules, and/or the like), a location and/or identifier of infrastructure and/or software impacted by the network anomaly (such as an IP address, MAC address, datacenter location, server rack, virtual server address, and/or the like), an action to interact with the infrastructure and/or software impacted by the network anomaly, and/or responsive communications to transmit to a predetermined recipient list (e.g., engineers, end users, network devices, and/or the like). According to some embodiments, the mapping may comprise generating a template response form for transmitting communications associated with the network anomaly.

As shown in block 412, the process flow 400 may include the step of initiating, using the AI engine, one or more network anomalies remediations associated with the network anomaly. According to some embodiments, the one or more network anomalies remediations associated with the network anomaly may comprise responsive actions generated and/or executed by the AI engine to mitigate the network anomaly. In some embodiments, the responsive actions may comprise restoring a server and/or database and/or application to previous version, removing malicious code, removing access from the unauthorized and/or unauthenticated network device, deploying new code packages to a server and/or database and/or application, transferring network traffic to one or more new servers, replacing versions of code and/or module and/or application that are no longer supported internally and/or via an external vendor with supported versions, apply a missing critical security patch, revise privacy settings to meet and/or exceed privacy threshold, revise data security settings to meet and/or exceed a security threshold, revise access controls to meet and/or exceed an access security threshold, shut down a network associated with the network anomaly, open a network port, shut down a network port associated with the network anomaly, restrict traffic to a predetermined network port, and/or the like.

According to some embodiments, the one or more network anomalies remediations may comprise at least one of receiving, using the communication linkage, one or more responsive actions to remediate the network anomaly and impacted artifacts, wherein the impacted artifacts comprise at least one of an application, server, database, or one or more end users; generating, using the AI engine, a description associated with the one or more responsive actions (such as documenting the network anomaly, the root cause for the network anomaly, which one or more responsive actions were selected and why, and/or maintenance and/or downtime associated with the one or more responsive actions); transmitting, using the communication linkage, the one or more responsive actions to one or more predetermined network devices (such as a recipient list of users associated with network devices); and/or transmitting the one or more responsive actions to an internal remediation repository. In some embodiments, the internal remediation repository may comprise a knowledge management system used to train the AI engine as a recursive feedback loop for preventing network anomalies in the future by identifying preventative responsive actions and/or serve as a reference manual for resolving network anomalies.

In some embodiments, a notification may be generated and/or transmitted comprising the one or more responsive actions. The notification may comprise a communication transmission, wherein the communication transmission may comprise text data, audio data, visual data, and/or the like. In some embodiments, the notification may be transmitted via an Extract, Transform, and Load (ETL) process, transmitted to a network device, and/or transmitted to a user device.

In some embodiments, the system and/or AI engine may implement the one or more network anomalies remediations, monitor the success of the implemented one or more network anomalies remediations, and/or transmit alerts associated with the success and/or failure of each of the implemented one or more network anomalies remediations.

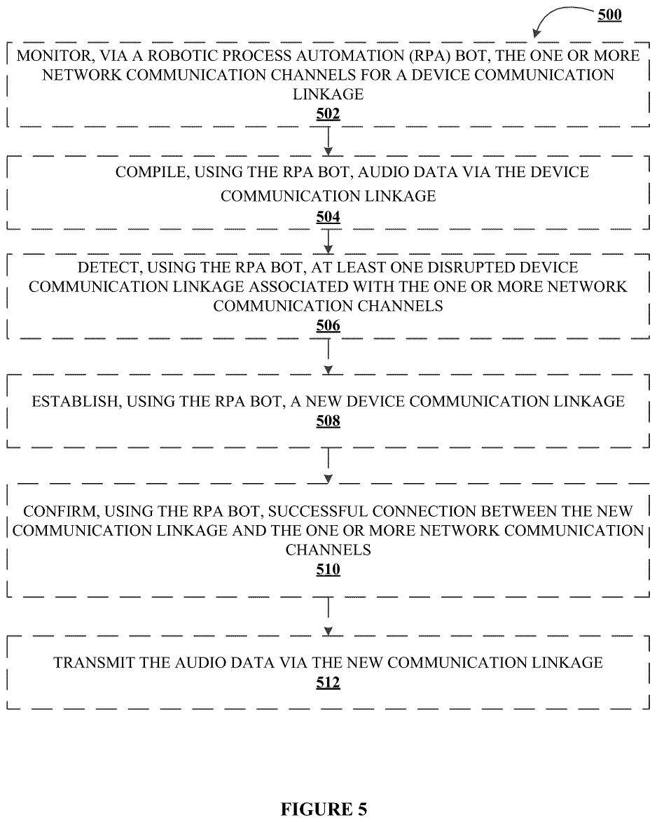

FIG. 5 illustrates a process flow 500 for monitoring one or more network communication channels using an RPA bot. In some embodiments, a system (e.g., similar to one or more of the systems described herein with respect to FIGS. 1A-1C) may perform one or more of the steps of process flow 500. For example, a real time networked communication monitoring, remediation, and alerting using generative technologies system (e.g., the system 130 described herein with respect to FIGS. 1A-1C) may perform the steps of process flow 500. In some embodiments, an AI engine (e.g., such as the AI engine like that described in FIG. 2) or a generative AI subsystem (e.g., such as the generative AI subsystem described in FIG. 3) may perform some or all of the steps described in process flow 500.

As shown in block 502, the process flow 500 may include the step of monitoring, via an RPA bot, the one or more network communication channels for a device communication linkage. In some embodiments, the RPA bot may be deployed to monitor the one or more network communication channels once the communication linkage is established. The RPA bot may continuously monitor each device communication linkage associated with each network device in network communication with the one or more communication channels while network communications transmissions are being transmitted via the one or more communication channels and/or the communication linkage. The device communication linkage may comprise a network connection between the one or more communication channels and a network device, according to some embodiments.

The RPA bot may monitor in real-time the network connectivity between the one or more communication channels and the network device to ensure the network device is receiving all network communication transmissions from the one or more communication channels. In some embodiments, a plurality of RPA bots may be deployed for monitoring, such as when at least two communications channels are being utilized concurrently for transmitting network communication transmissions associated with remediating the network anomaly. In some embodiments, the RPA bot may be assigned for monitoring randomly, via an RPA bot queue, based on network access controls associated with the RPA bot's permissions, and/or the like.

As shown in block 504, the process flow 500 may include the step of compiling, using the RPA bot, audio data via the device communication linkage. In some embodiments, the RPA bot may record to a data storage repository the one or more network communication transmissions transmitted via the one or more communication channels to the network device via the device communication linkage, wherein the one or more network communication transmissions may comprise audio data and/or text data. By recording audio data transmitted to the network device, the RPA bot ensures one or more complete copies exist of the audio data for analysis, archival purposes, and/or for transmitting to a network device that lacks a device communication linkage.

As shown in block 506, the process flow 500 may include the step of detecting, using the RPA bot, at least one disrupted device communication linkage associated with the one or more network communication channels. In some embodiments, the RPA bot may trigger pings between the network device and the one or more network communication channels to check for disruptions to the device communication linkage. The pings may comprise targeted network data packets from the network device to network equipment associated with the one or more network communication channels. In some embodiments, the RPA bot may leverage tracerouting to monitor network connectivity between the network device and the one or more network communication channels. The RPA bot may detect at least one disrupted device communication linkage associated with the one or more network communication channels when pings are not returned and/or when tracerouting identifies an anomaly path for the test data packets. In some embodiments, the RPA bot may re-attempt pinging and/or tracerouting one or more additional times to confirm at least one disrupted device communication linkage associated with the one or more network communication channels.

As shown in block 508, the process flow 500 may include the step of establishing, using the RPA bot, a new device communication linkage. According to some embodiments, the RPA bot may trigger initiation of a new device communication linkage. In some embodiments, the new device communication linkage may comprise an update of the device communication linkage, which may comprise restored connectivity with the one or more network communications channels, and/or at least one additional device communication linkage to replace the original device communication linkage. The new device communication linkage may comprise network connectivity between the network device and the one or more network communication channels. The new device communication linkage, in some embodiments, may comprise an encrypted network transmission channel, secure socket layer (SSL), TCP/IP, and/or connected network communication pathway comprising nodes and edges.

As shown in block 510, the process flow 500 may include the step of confirming, using the RPA bot, successful connection between the new communication linkage and the one or more network communication channels. In some embodiments, the system and/or RPA bot may transmit test network transmissions to ensure a successful connection between the new communication linkage and the one or more network communication channels. According to some embodiments, if an initial test to confirm successful connection is unsuccessful, the RPA bot may trigger one or more additional tests to determine whether the issue an error alert and/or confirm the successful connection. In some embodiments, the RPA bot may log each test and/or test network transmissions and transmit the log.

As shown in block 512, the process flow 500 may include the step of transmitting the audio data via the new communication linkage. In some embodiments, prior to transmission of the audio data, the system may execute an authentication to ensure the audio data only is transmitted to an authenticated and/or permitted recipient and/or network device. The authentication may comprise one or more authentication methods (e.g., authentication credentials, digital certificates, centralized authentication server, ticket-based protocol, token-based authentication, multi-factor, single sign-on, authentication application, Remote Authentication Dial-In User Service protocol, Open Authorization protocol, OpenID Connect, and/or the like), each of which may selected dynamically by the AI engine based on one or more criteria (e.g., the one or more network communication channels, data security requirements, criticality of the network anomaly, and/or the like).

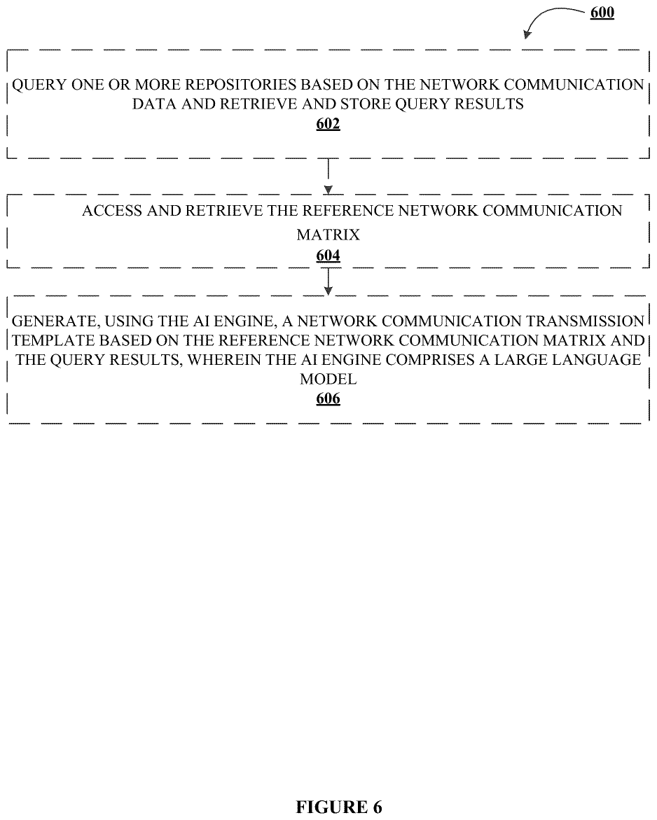

FIG. 6 illustrates a process flow 600 for generating a network communication transmission template, in accordance with an embodiment of the disclosure. In some embodiments, a system (e.g., similar to one or more of the systems described herein with respect to FIGS. 1A-1C) may perform one or more of the steps of process flow 600. For example, a real time networked communication monitoring, remediation, and alerting using generative technologies system (e.g., the system 130 described herein with respect to FIGS. 1A-1C) may perform the steps of process flow 600. In some embodiments, an AI engine (e.g., such as the AI engine like that described in FIG. 2) or a generative AI subsystem (e.g., such as the generative AI subsystem described in FIG. 3) may perform some or all of the steps described in process flow 600.

As shown in block 602, the process flow 600 may include the step of querying one or more repositories based on the network communication data and retrieve and store query results. In some embodiments, the AI engine may generate at least one query, based on the network communication data, for the querying the one or more repositories. The one or more repositories may comprise systems of records, one or more applications, one or more modules, one or more code repositories, one or more accounts, one or more databases, one or more data lakes, and/or the like. In some embodiments, storing the query results may comprise retrieving query results and storing them in a temporary database, staging table, intermediate repository, and/or the like.

As shown in block 604, the process flow 600 may include the step of accessing and retrieving the reference network communication matrix. In some embodiments, accessing the reference network communication matrix may comprise executing an authentication to access a repository, accessing a repository storing the reference network communication matrix, retrieving the reference network communication matrix from the repository, and/or generating a copy of the reference network communication matrix. In some embodiments, the reference network communication matrix may be received by receiving network data packets comprising the reference network communication matrix.

As shown in block 606, the process flow 600 may include the step of generating, using the AI engine, a network communication transmission template based on the reference network communication matrix and the query results, wherein the AI engine comprises a large language model. In some embodiments, the AI engine, which may comprise a large language model, comprises a generative AI agent. The generative AI agent may generate the network communication transmission template by incorporating the query results into fields within the reference network communication matrix, such as replacing null fields and/or replacing temporary data with data from the query results. In some embodiments, the network communication transmission template may require additional data missing from the query results, which may trigger the generative AI agent to identify missing data and search one or more repositories to retrieve such missing data and/or generate a transmission to one or more recipients to provide the missing data. By leveraging the AI engine to ensure missing data is identified and retrieved, the system improves the accuracy and completeness of generating network communication transmission templates.

In some embodiments, the network communication transmission template may comprise templates for generating network communications in response to a request and/or query received from a network device and/or end user. The network communication transmission template may be tailored for certain recipients, such as a predetermined set of network devices and/or devices associated with an end user. By way of non-limiting example, and in some embodiments, the network communication transmission template may comprise detailed technical descriptors, data, and/or metadata associated with the network anomaly and/or one or more network anomalies remediation, such as impacted infrastructure and/or applications (for example, when transmitting to a recipient that has access to impacted infrastructure and/or applications, or may possess technical expertise to comprehend technical challenges posed by the network anomaly), and/or the network communication transmission template may comprise descriptors associated with impacts to end users (that may now lack requisite infrastructure and/or access to one or more applications due to the network anomaly), answers to frequently asked questions, forecast timeline to remediate the network anomaly, and/or the like. By preparing a network communication transmission template tailored to the intended recipient, the present disclosure is configured to provide communications that are pertinent and easily understood by the intended recipient. Because the system may provide customized network communication transmission templates, it improves the efficiency and performance of real time networked communication monitoring, remediation, and alerting using generative technologies system

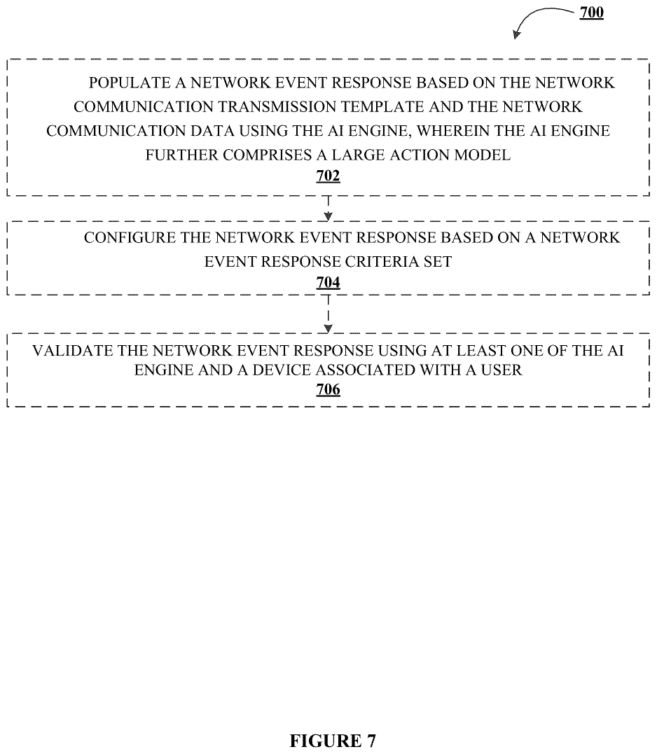

FIG. 7 illustrates a process flow 700 for populating and validating a network event response, in accordance with an embodiment of the disclosure. In some embodiments, a system (e.g., similar to one or more of the systems described herein with respect to FIGS. 1A-1C) may perform one or more of the steps of process flow 700. For example, a real time networked communication monitoring, remediation, and alerting using generative technologies system (e.g., the system 130 described herein with respect to FIGS. 1A-1C) may perform the steps of process flow 700. In some embodiments, an AI engine (e.g., such as the AI engine like that described in FIG. 2) or a generative AI subsystem (e.g., such as the generative AI subsystem described in FIG. 3) may perform some or all of the steps described in process flow 700.

As shown in block 702, the process flow 700 may include the step of populating a network event response based on the network communication transmission template and the network communication data using the AI engine, wherein the AI engine further comprises a large action model. In some embodiments, the AI engine may be authenticated via one or more authentication methods (e.g., authentication credentials, digital certificates, centralized authentication server, ticket-based protocol, token-based authentication, multi-factor, single sign-on, authentication application, and/or the like) prior to populating the network event response to prevent unauthorized access to sensitive data and to editing the network event response without required authorization. The system and/or a user associated with an authenticated network device may dynamically select the one or more authentication methods for authenticating the AI engine.

According to some embodiments, populating the network event response based on the network communication transmission template and the network communication data using the AI engine may comprise evaluating the network communication transmission template and the network communication data, using the AI engine, to determine one or more repositories to access, query, and/or extract data to include in the network event response. The AI engine may make a network event response determination comprising requirements to access required missing data, generate and execute a query based on the network event response determination, and retrieve such query results.

In some embodiments, the large action model may comprise a deep learning model that may populate the network event response based on evaluating the network communication transmission template and the network communication data, determining how to generate inputs for inclusion in the network event response (such as querying and accessing systems as set forth in the foregoing), and/or generating and transmitting a request for missing data and receiving such missing data to include in the network event response. By way of non-limiting example, and in some embodiments, the AI engine may determine, based on the network communication transmission template and the network communication data, that the network event response may require technical descriptors of the network anomaly, a timestamp of detection of the network anomaly, whether a root cause of the network anomaly has been identified (and specify the root cause if known), infrastructure impacted by the network anomaly (such as identifying the data center, server, database, server rack, cloud cluster, and/or the like), application and/or software services impacted by the network anomaly (such as front-end applications, back-end applications, email application, web-based enterprise systems, systems of record, desktop-based applications, and/or the like), operating system of infrastructure impacted by the network anomaly, one or more identifiers for resources working to remediate the network anomaly (such as name, name of team, network device identifier, and/or the like), communication method for additional information, forecast network anomaly remediation timeframe, functionality impacted by the network anomaly (such as inability and/or reduced ability to query repositories, executing calls via application programming interfaces, ping network devices, and/or executing command line instructions), a descriptor associated with impacts to end users (such as describing lack of access to an application, dashboard, application platform, database, and/or enterprise service), and/or forecast impacts to added resource consumption associated with remediating the network anomaly (such as network environment downtime, additional computing resource requirements, and/or the like). By utilizing an AI engine, which may comprise a large action model, the system efficiently and accurately populates the network event response in a scalable manner, thereby facilitating the remediation of the network anomaly.

As shown in block 704, the process flow 700 may include the step of configuring the network event response based on a network event response criteria set. In some embodiments, the network event response criteria set may be predetermined and stored in a repository (which may be accessed and retrieved while configuring the network event response, determined dynamically by the AI engine based on the network communication transmission template and the network communication data, and/or selected by an authorized user associated with an authenticated network device.

According to some embodiments, the network event response criteria set may comprise one or more recipients (such as distribution lists, designated network devices, and/or internal and/or external recipients), parameters for transmitting the network event response (such as transmitting dynamically upon receipt of a request for the network event response, delaying on transmitting the network event response until specific windows of hours during a workday and/or the next weekday and/or for avoiding holidays, and/or filtering out certain content from the network event response). Filtering certain content from the network event response may be necessary when transmitting the network event response to a non-technical recipient list, recipients who are unfamiliar with certain concepts in the network event response, recipients who lack access to certain infrastructure and/or applications in the network event response.

As shown in block 706, the process flow 700 may include the step of validating the network event response using at least one of the AI engine and a device associated with a user. In some embodiments, the network event response may undergo validation prior to transmission of the network event response to identify and correct errors, confirm recipient lists, and/or the like. The AI engine may validate the network event response by confirming data in the network event response via comparisons to data stored in one or more repositories, generating transmissions to an authenticated user to validate the data, and/or editing the network event response based on the foregoing repository querying and/or receipt of confirmation and/or required edits by the user. In some embodiments, an authenticated and authorized user associated with an authenticated network device may pause transmission of the network event response, cancel the network event response, and/or edit the network event response prior to transmission.

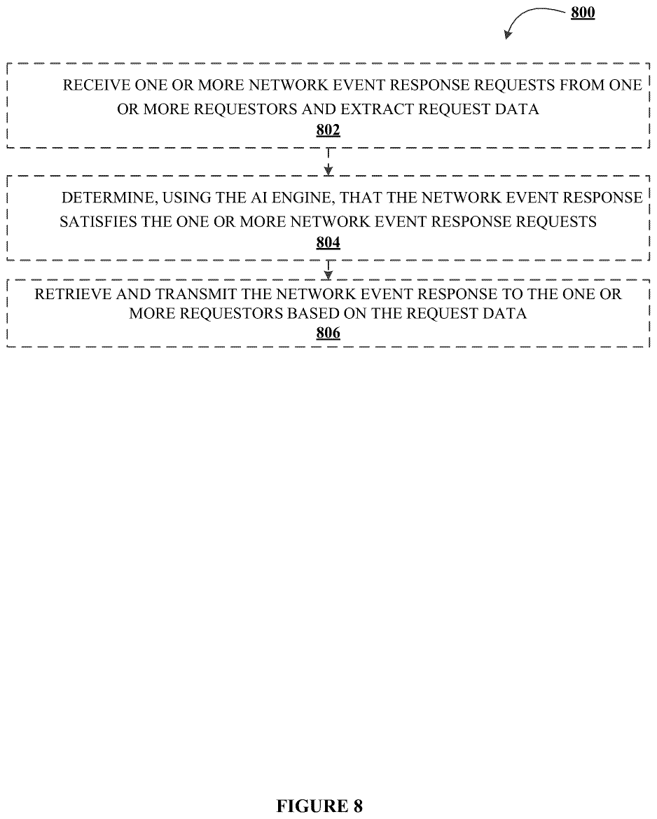

FIG. 8 illustrates a process flow 800 for evaluating and transmitting the network event response based on one or more network event response requests, in accordance with an embodiment of the disclosure. In some embodiments, a system (e.g., similar to one or more of the systems described herein with respect to FIGS. 1A-1C) may perform one or more of the steps of process flow 800. For example, a real time networked communication monitoring, remediation, and alerting using generative technologies system (e.g., the system 130 described herein with respect to FIGS. 1A-1C) may perform the steps of process flow 800. In some embodiments, an AI engine (e.g., such as the AI engine like that described in FIG. 2) or a generative AI subsystem (e.g., such as the generative AI subsystem described in FIG. 3) may perform some or all of the steps described in process flow 800.

As shown in block 802, the process flow 800 may include the step of receiving one or more network event response requests from one or more requestors and extracting request data. In some embodiments, the one or more network event response requests may be received via an application, which may comprise a generative AI agent that interacts with the one or more requestors. The one or more network event response requests may comprise audio and/or text data transmitted via data packets via the communication linkage, encrypted data pipeline, ETL process, and/or the like. The one or more network event response requests may be received dynamically, via batch processing, via in-series processing, and/or via parallel processing. Prior to receiving the one or more network event response requests, the one or more requestors may be authenticated to enhance the security of the system.

According to some embodiments, the request data may comprise an identifier associated with the one or more requestors, a requested deadline for responding to the one or more network event response requests, infrastructure and/or applications associated with the one or more network event response requests and/or one or more requestors, a requested status update to remediate the network anomaly, forecast timeframe to remediate the network anomaly, and/or the like.

As shown in block 804, the process flow 800 may include the step determining, using the AI engine, that the network event response satisfies the one or more network event response requests. In some embodiments, a natural language processing algorithm may be utilized by the AI engine to validate that the network event response satisfies the one or more network event response requests by parsing the one or more network event response requests and/or the request data to determine response requirements and evaluating the network event response, using the natural language processing algorithm, to validate that the response requirements are met.

According to some embodiments, the network event response may be fully responsive to the one or more network event response requests. By way of non-limiting example, and in some embodiments, the network event response request and/or request data may comprise a request for immediate response, network anomaly identification, network anomaly root cause, network anomaly remediation assignment (such as identifying assignment of the remediation to one or more remediation teams), impacted infrastructure, impacted applications, impacted deployment environments (such as production, quality assurance/test, and/or the like), and/or estimated timeframe for completing remediation of the network anomaly. The AI engine may determine that the generated network event response may fully answer, satisfy, comply with, and/or be fully responsive to each of the foregoing aspects of the network event response request. The AI engine may log and timestamp that the network event response satisfies the one or more network event response requests and/or transmit the log to a network event response log repository and/or network device associated with logging network event responses.

As shown in block 806, the process flow 800 may include the step of retrieving and transmitting the network event response to the one or more requestors based on the request data. In some embodiments, retrieving the network event response may comprise executing an authentication in order to access the network event response. The authentication may comprise one or more authentication methods (e.g., authentication credentials, digital certificates, centralized authentication server, ticket-based protocol, token-based authentication, multi-factor, single sign-on, authentication application, Remote Authentication Dial-In User Service protocol, Open Authorization protocol, OpenID Connect, and/or the like), each of which may selected dynamically by the AI engine based on one or more criteria (e.g., the one or more network communication channels, data security requirements, criticality of the network anomaly, identity of the one or more requestors, and/or the like). The network event response may be stored in one or more repositories, memory locations, and/or the like. In some embodiments retrieving the network event response may comprise generating and executing a query, via the AI engine, to access and retrieve the network event response from a repository.

In some embodiments, transmitting the network event response may comprise executing an authentication (e.g., authentication credentials, digital certificates, centralized authentication server, ticket-based protocol, token-based authentication, multi-factor, single sign-on, authentication application, Remote Authentication Dial-In User Service protocol, Open Authorization protocol, OpenID Connect, and/or the like) of the one or more requestors to validate the network event response may be transmitted to the correct recipient. Transmitting the network event response may be executed via transmitting network data packets, via an ETL process, and/or a communication transmission, wherein the communication transmission may comprise text data, audio data, visual data, and/or the like. The network event response may be transmitted via the communication linkage, email, audio call, text message, and/or the like.

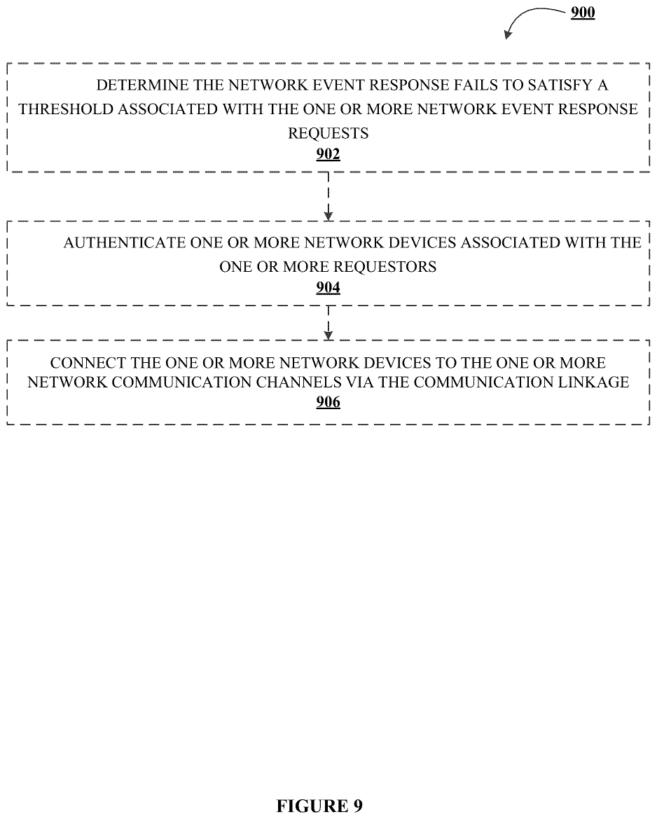

FIG. 9 illustrates a process flow 900 for connecting one or more network devices based on a threshold determination, in accordance with an embodiment of the disclosure. In some embodiments, a system (e.g., similar to one or more of the systems described herein with respect to FIGS. 1A-1C) may perform one or more of the steps of process flow 900. For example, a real time networked communication monitoring, remediation, and alerting using generative technologies system (e.g., the system 130 described herein with respect to FIGS. 1A-1C) may perform the steps of process flow 900. In some embodiments, an AI engine (e.g., such as the AI engine like that described in FIG. 2) or a generative AI subsystem (e.g., such as the generative AI subsystem described in FIG. 3) may perform some or all of the steps described in process flow 900.

As shown in block 902, the process flow 900 may include the step of determining the network event response fails to satisfy a threshold associated with the one or more network event response requests. In some embodiments, the AI engine may utilize a natural language processing algorithm to determine that the network event response may fail to satisfy the threshold associated with the one or more network event response requests. The threshold may comprise quantitative and/or qualitative criteria that determines that the network event response is not fully responsive to the one or more network event response requests (such as lacking response data and/or failing to answer questions from the one or more network event response requests). In some embodiments, the threshold may comprise feedback from the one or more requestors that the network event response may fail to fully satisfy the one or more network event response requests. According to some embodiments, the threshold may comprise a predetermined criteria set for the network event response, wherein the predetermined criteria set may comprise response times, network event response accuracy, and/or network event response completeness.

In some embodiments, the AI engine may query one or more repositories and/or transmit request transmissions based on the threshold to one or more network devices to receive the missing data and then retransmit the received data to the one or more requestors via a supplemental network event response. According to some embodiments, the supplemental network event response may satisfy the threshold and/or one or more network event response requests. In some embodiments, the AI engine may determine that the supplemental network event response may not satisfy the threshold and/or one or more network event response requests.

As shown in block 904, the process flow 900 may include the step of authenticating one or more network devices associated with the one or more requestors. In some embodiments, authenticating one or more network devices associated with the one or more requestors may comprise one or more authentication methods (e.g., authentication credentials, digital certificates, centralized authentication server, ticket-based protocol, token-based authentication, multi-factor, single sign-on, authentication application, Remote Authentication Dial-In User Service protocol, Open Authorization protocol, OpenID Connect, and/or the like), each of which may selected dynamically by the AI engine based on one or more criteria (e.g., the one or more network communication channels, data security requirements, criticality of the network anomaly, and/or the like). In some embodiments, upon successful authentication, an authentication confirmation message may be transmitted to the one or more network devices associated with the one or more requestors. If authentication fails, the AI engine may determine to attempt authentication one or more additional times and/or flag the failed authentication as anomalous network activity and transmit a security alert.

As shown in block 906, the process flow 900 may include the step of connecting the one or more network devices to the one or more network communication channels via the communication linkage. In some embodiments, connecting the one or more network devices to the one or more network communication channels via the communication linkage may comprise utilizing a network interface to establish network connectivity between the one or more network devices to the one or more network communication channels via the communication linkage. According to some embodiments, connecting the one or more network devices to the one or more network communication channels via the communication linkage may comprise establishing one or more device communication linkages associated with the one or more network devices. In some embodiments, the AI engine may determine that the one or more network devices to the one or more network communication channels via the communication linkage established successful network connectivity. In some embodiments, the system may transmit a message, via the communication linkage, to the one or more network communication channels communicating the connection of the one or more network devices to the one or more network communication channels via the communication linkage. By connecting the one or more network devices to the one or more network communication channels, the system enhances the security of network communications and facilitates the one or more requestors receiving additional, secure network communications via the communication linkage.

In some embodiments, upon successful connection, a connection confirmation message may be transmitted to the one or more network devices associated with the one or more requestors and/or the one or more communication channels. If the connection fails, the AI engine may determine to attempt connection one or more additional times and/or flag the failed connection as anomalous network activity and transmit a security alert.

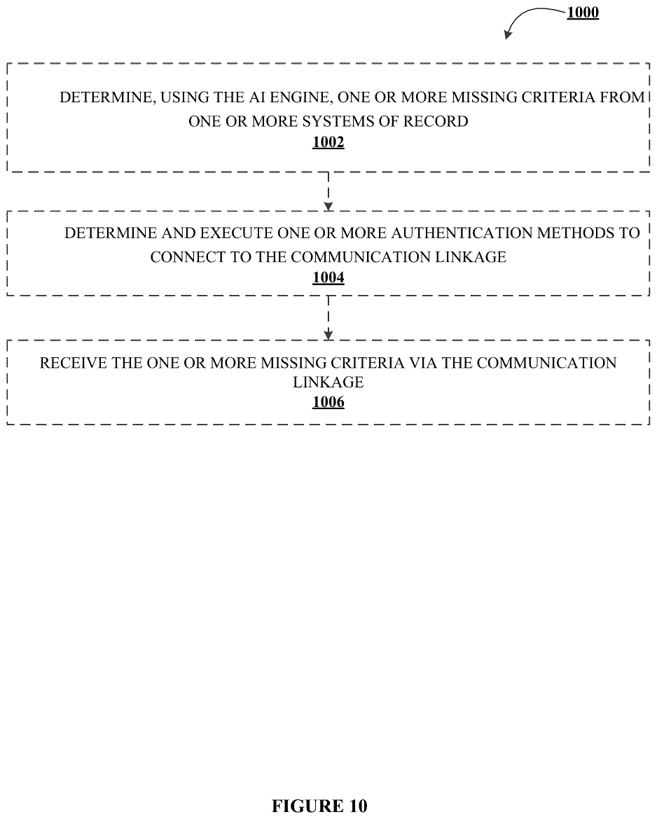

FIG. 10 illustrates a process flow 1000 for receiving one or more missing criteria, in accordance with an embodiment of the disclosure. In some embodiments, a system (e.g., similar to one or more of the systems described herein with respect to FIGS. 1A-1C) may perform one or more of the steps of process flow 1000. For example, a real time networked communication monitoring, remediation, and alerting using generative technologies system (e.g., the system 130 described herein with respect to FIGS. 1A-1C) may perform the steps of process flow 1000. In some embodiments, an AI engine (e.g., such as the AI engine like that described in FIG. 2) or a generative AI subsystem (e.g., such as the generative AI subsystem described in FIG. 3) may perform some or all of the steps described in process flow 1000.

As shown in block 1002, the process flow 1000 may include the step of determining, using the AI engine, one or more missing criteria from one or more systems of record. In some embodiments, the AI engine may query one or more systems or records, repositories, data lakes, and/or the like to determine that there are one or more missing criteria, and as a result, the network communication transmission template and/or network event response cannot be generated. According to some embodiments, the one or more missing criteria may be required data to generate the network communication transmission template and/or network event response, initiate one or more network anomalies remediations, and/or the like.

As shown in block 1004, the process flow 1000 may include the step of determining and executing one or more authentication methods to connect to the communication linkage. The one or more authentication methods may comprise authentication credentials, digital certificates, centralized authentication server, ticket-based protocol, token-based authentication, multi-factor, single sign-on, authentication application, Remote Authentication Dial-In User Service protocol, Open Authorization protocol, OpenID Connect, and/or the like, each of which may selected dynamically by the AI engine based on security criteria (such as sensitivity of data, required expediency for the authentication, privacy requirements, access control requirements, and/or the like). In some embodiments, upon successful authentication, an authentication confirmation message may be transmitted. If authentication fails, the AI engine may determine to attempt authentication one or more additional times and/or transmit a failed authentication alert.

As shown in block 1006, the process flow 1000 may include the step of receiving the one or more missing criteria via the communication linkage. In some embodiments, upon authentication, the system and/or AI engine may transmit, via the communication linkage, the one or more missing criteria to the one or more communication channels. The transmission may comprise audio data and/or text data. The AI engine may actively monitor network communication transmissions to determine if the one or more missing criteria have been transmitted via the communication linkage. In some embodiments, the one or more communication channels may directly transmit the one or more missing criteria via the communication linkage. The AI engine may validate that the received transmission comprises the one or more missing criteria and/or transmit a confirmation message.

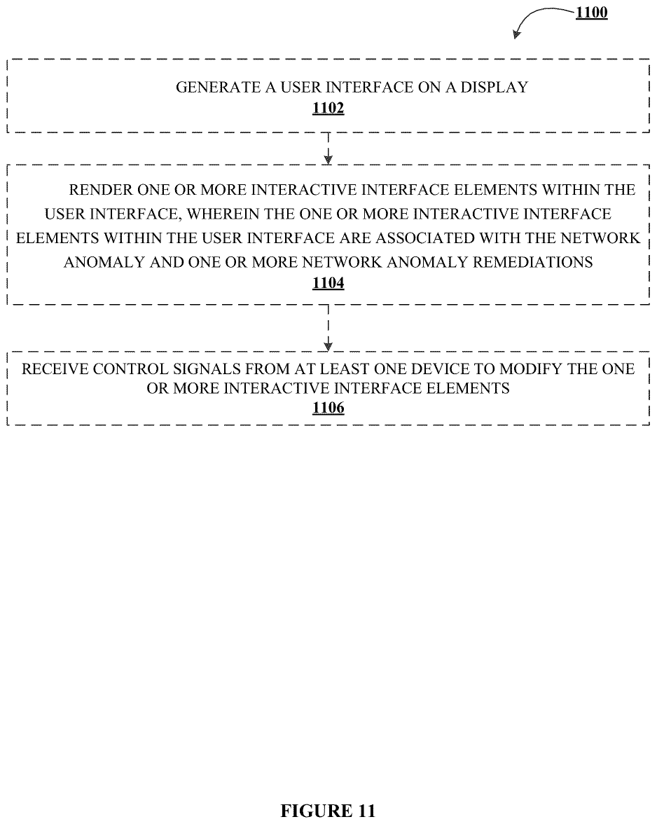

FIG. 11 illustrates a process flow 1100 for rendering and modifying one or more interactive interface elements, in accordance with an embodiment of the disclosure. In some embodiments, a system (e.g., similar to one or more of the systems described herein with respect to FIGS. 1A-1C) may perform one or more of the steps of process flow 1100. For example, a real time networked communication monitoring, remediation, and alerting using generative technologies system (e.g., the system 130 described herein with respect to FIGS. 1A-1C) may perform the steps of process flow 1100. In some embodiments, an AI engine (e.g., such as the AI engine like that described in FIG. 2) or a generative AI subsystem (e.g., such as the generative AI subsystem described in FIG. 3) may perform some or all of the steps described in process flow 1100.

As shown in block 1102, the process flow 1100 may include the step of generating a user interface on a display. According to some embodiments, the user interface may be disposed within a display device, mixed reality headset, projector system, mobile device, glasses, and/or the like. The user interface may comprise input devices and output devices, including without limitation physical buttons, capacitive touch buttons, digital icons and buttons, audio transmitter, audio receiver, microphone, speakers, headphones, telephones, computers, and/or mobile applications, according to some embodiments.

As shown in block 1104, the process flow 1100 may include the step of rendering one or more interactive interface elements within the user interface, wherein the one or more interactive interface elements within the user interface are associated with the network anomaly and one or more network anomaly remediations. According to some embodiments, the one or more interactive interface elements may comprise menus, channels associated with the network anomaly and/or one or more network anomalies remediations and/or request for data associated with the network anomaly, icons, digital buttons, dashboards associated with the network anomaly and/or one or more network anomalies remediations and/or request for data associated with the network anomaly, digital objects, and/or the like. The one or more interactive elements may activate upon selection, interaction, and/or input from the user, according to some embodiments.

As shown in block 1106, the process flow 1100 may include the step of receiving control signals from at least one device to modify the one or more interactive interface elements. According to some embodiments, the control signals may be associated with input devices, mobile device, one or more network devices, the interactive interface elements, microphone, audio transmitter, and/or the like. By way of non-limiting example, and in some embodiments, a user may interact with the one or more interactive interface elements, which may generate control signals. According to some embodiments, the control signals may be associated with the network anomaly and/or one or more network anomalies remediations and/or request for data associated with the network anomaly.

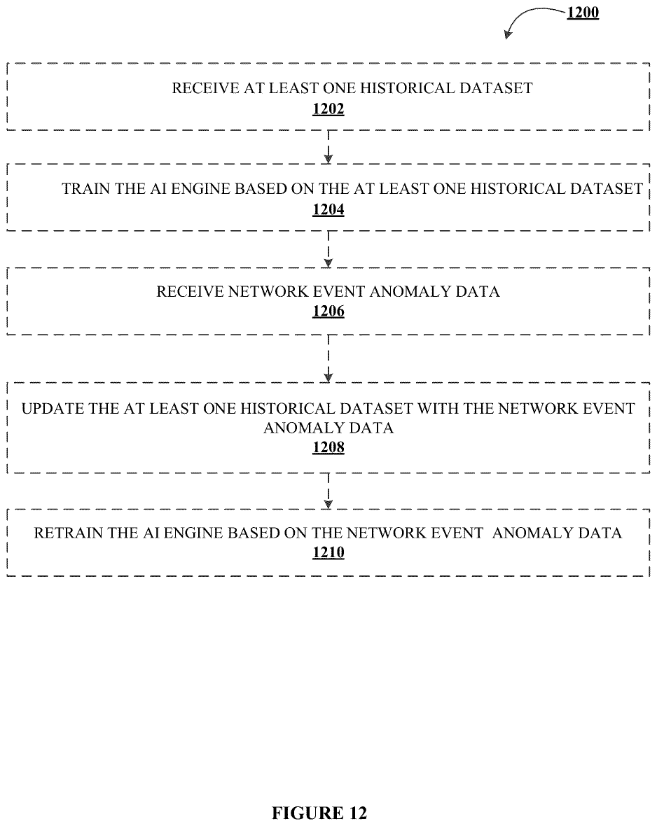

FIG. 12 illustrates a process flow 1200 for training and retraining the AI engine. In some embodiments, a system (e.g., similar to one or more of the systems described herein with respect to FIGS. 1A-1C) may perform one or more of the steps of process flow 1200. For example, a real time networked communication monitoring, remediation, and alerting using generative technologies system (e.g., the system 130 described herein with respect to FIGS. 1A-1C) may perform the steps of process flow 1200. In some embodiments, an AI engine (e.g., such as the AI engine like that described in FIG. 2) or a generative AI subsystem (e.g., such as the generative AI subsystem described in FIG. 3) may perform some or all of the steps described in process flow 1200.

As shown in block 1202, the process flow 1200 may include the step of receiving at least one historical dataset. The at least one historical dataset may be stored in an internal data repository, hosted externally by an external network administrator, and/or the like. In some embodiments, the system may collect, compile, and/or aggregate historical data to create the at least one historical dataset and may store the at least one historical dataset in an internal data repository. In such a configuration, the system may access and retrieve the at least one historical dataset each time the AI engine may be trained, wherein the AI engine may comprise an AI engine, AI model, generative AI model, AI application, and/or the like. In some embodiments, the system may receive the at least one historical dataset continuously, at set internals, and/or via on-demand request generated by the AI engine, a user, an AI engine training controller, network device, and/or the like. In some embodiments, the system may receive the entire at least one historical dataset. According to sone embodiments, the system may only receive a subset of data contained within the at least one historical dataset based on training requirements associated with an AI engine training request generated by the system, user, network device, and/or the like. By training the AI engine on only a subset of the at least one historical dataset based on the most material and/or relevant data, the system may conserve computing resources, minimize energy expenditures, and/or enhance the AI engine performance. In some embodiments, the subset of data may not comprise sensitive data, preventing the inclusion of sensitive data in training the AI engine, which enhances data security and privacy.

As shown in block 1204, the process flow 1200 may include the step of training the AI engine based on the at least one historical dataset. In some embodiments, the at least one historical dataset comprises historical one or more network communication transmissions, historical network anomalies, historical one or more network anomalies remediations, historical network communication data, historical reference network communication matrices, historical network transmission enrichment protocols, and/or the like. In some embodiments the AI engine may comprise a generative AI model, in which training the generative AI model may comprise ingesting the historical dataset, adjusting parameters in response to generative AI model output, evaluating the model for fine-tuning, and/or deploying the generative AI model.

As shown in block 1206, the process flow 1200 may include the step of receiving network event anomaly data. In some embodiments, receiving the network event anomaly data may comprise receiving network data packets comprising network event anomaly data. In some embodiments, a data aggregator may collect network event anomaly data to generate aggregated network event anomaly data and transmit the aggregated network event anomaly data via network data packets to the system and/or AI engine. In some embodiments, the data aggregator may pre-process the network event anomaly data, such as data cleansing, encrypting, and/or executing an ETL process. In some embodiments, the system may process the received network data packets, such as executing decryption, data extraction, and/or the like.

As shown in block 1208, the process flow 1200 may include the step of updating the at least one historical dataset with the network event anomaly data. In some embodiments, the network event anomaly data may be attached to the at least one historical dataset. In such a configuration, an ETL process may be executed to transmit the network event anomaly data dataset to the same data storage repository as the at least one historical dataset.

As shown in block 1210, the process flow 120 may include the step of retraining the AI engine based on the network event anomaly data. The retraining step may be executed via feedback loop for continuous retraining and/or the retraining may occur via internal-based batch jobs, according to some embodiments. In some embodiments, the AI engine may refine itself by revising its weights and other such decision factors to improve accuracy, speed, and minimize errors, based on an AI engine training confidence threshold. In some embodiments, the system may determine the AI engine training confidence threshold, and if the AI engine training confidence threshold is below a given confidence threshold (e.g., predetermined, determined via notification from a network device, and/or dynamically determined by the system), the system may trigger retraining of the AI engine. In some embodiments, if criteria (e.g., criteria for real time networked communication monitoring, remediation, and alerting associated with anomaly detection and remediation) and/or network event anomaly data are generated and/or received by the system and/or AI engine (hereinafter referred to as “new training factors”), then the system and/or AI engine may trigger in real-time retraining of the AI engine based on the new training factors. By constantly monitoring for new training factors and triggering a responsive real-time retraining, the system provides a technical solution to the challenge of monitoring new training factors and changing network traffic conditions and adjusting the system dynamically.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for real time networked communication monitoring, remediation, and alerting using generative technologies, the system comprising:
a memory device with computer-readable program code stored thereon;
at least one processing device, wherein executing the computer-readable program code is configured to cause the at least one processing device to execute the computer-readable program code to:
initiate a communication linkage with one or more network communication channels;
compile and extract one or more network communication transmissions associated with a network anomaly from the one or more network communication channels;
execute, using an artificial intelligence (AI) engine, a network transmission enrichment protocol based on the one or more network communication transmissions;
extract, using the AI engine, network communication data based on the network transmission enrichment protocol;
map, using the AI engine, the network communication data to a reference network communication matrix; and
initiate, using the AI engine, one or more network anomalies remediations associated with the network anomaly.

2. The system of claim 1, wherein executing the computer-readable program code is further configured to cause the at least one processing device to:
monitor, via a robotic process automation (RPA) bot, the one or more network communication channels for a device communication linkage;
compile, using the RPA bot, audio data via the device communication linkage;
detect, using the RPA bot, at least one disrupted device communication linkage associated with the one or more network communication channels;
establish, using the RPA bot, a new device communication linkage;
confirm, using the RPA bot, successful connection between the new communication linkage and the one or more network communication channels; and
transmit the audio data via the new communication linkage.

3. The system of claim 1, wherein executing the computer-readable program code is further configured to cause the at least one processing device to:
query one or more repositories based on the network communication data and retrieve and store query results;
access and retrieve the reference network communication matrix; and
generate, using the AI engine, a network communication transmission template based on the reference network communication matrix and the query results, wherein the AI engine comprises a large language model.

4. The system of claim 3, wherein executing the computer-readable program code is further configured to cause the at least one processing device to:
populate a network event response based on the network communication transmission template and the network communication data using the AI engine, wherein the AI engine further comprises a large action model;
configure the network event response based on a network event response criteria set; and
validate the network event response using at least one of the AI engine and a device associated with a user.

5. The system of claim 3, wherein executing the computer-readable program code is further configured to cause the at least one processing device to:
receive one or more network event response requests from one or more requestors and extract request data;
determine, using the AI engine, that the network event response satisfies the one or more network event response requests; and
retrieve and transmit the network event response to the one or more requestors based on the request data.

6. The system of claim 5, wherein executing the computer-readable program code is further configured to cause the at least one processing device to:
determine the network event response fails to satisfy a threshold associated with the one or more network event response requests;
authenticate one or more network devices associated with the one or more requestors; and
connect the one or more network devices to the one or more network communication channels via the communication linkage.

7. The system of claim 1, wherein the network transmission enrichment protocol comprises:
accessing and evaluating, using the AI engine, the one or more network communication transmissions to determine communication transmission attributes, wherein the AI engine further comprises a convolutional neural network; converting the one or more network communication transmissions to an alternate data type; and extracting, using the AI engine, metadata associated with the one or more network communication transmissions based on the alternate data type.

8. The system of claim 1, wherein executing the computer-readable program code is further configured to cause the at least one processing device to:
determine, using the AI engine, one or more missing criteria from one or more systems of record;
determine and execute one or more authentication methods to connect to the communication linkage; and
receive the one or more missing criteria via the communication linkage.

9. The system of claim 1, wherein the one or more network anomalies remediations comprise:
receiving, using the communication linkage, one or more responsive actions to remediate the network anomaly and impacted artifacts, wherein the impacted artifacts comprise at least one of an application, server, database, or one or more end users;
generating, using the AI engine, a description associated with the one or more responsive actions; transmitting, using the communication linkage, the one or more responsive actions to one or more predetermined network devices; and transmitting the one or more responsive actions to an internal remediation repository.

10. The system of claim 1, wherein executing the computer-readable program code is further configured to cause the at least one processing device to:
generate a user interface on a display;
render one or more interactive interface elements within the user interface, wherein the one or more interactive interface elements within the user interface are associated with the network anomaly and one or more network anomaly remediations; and
receive control signals from at least one device to modify the one or more interactive interface elements.

11. The system of claim 1, wherein executing the computer-readable program code is further configured to cause the at least one processing device to:
receive at least one historical dataset;
train the AI engine based on the at least one historical dataset;
receive network event anomaly data;
update the at least one historical dataset with the network event anomaly data; and
retrain the AI engine based on the network event anomaly data.

12. A computer program product for real time networked communication monitoring, remediation, and alerting using generative technologies, wherein the computer program product comprises at least one non-transitory computer-readable medium having computer-readable program code portion embodied therein, the computer-readable program code portions which when executed by a processing device are configured to cause a processor to:
initiate a communication linkage with one or more network communication channels;
compile and extract one or more network communication transmissions
associated with a network anomaly from the one or more network communication channels;
execute, using an artificial intelligence (AI) engine, a network transmission enrichment protocol based on the one or more network communication transmissions;
extract, using the AI engine, network communication data based on the network transmission enrichment protocol;
map, using the AI engine, the network communication data to a reference network communication matrix; and
initiate, using the AI engine, one or more network anomalies remediations associated with the network anomaly.

13. The computer program product of claim 12, wherein the processing device is further configured to:
monitor, via a robotic process automation (RPA) bot, the one or more network communication channels for a device communication linkage;
compile, using the RPA bot, audio data via the device communication linkage;
detect, using the RPA bot, at least one disrupted device communication linkage associated with the one or more network communication channels;
establish, using the RPA bot, a new device communication linkage;
confirm, using the RPA bot, successful connection between the new communication linkage and the one or more network communication channels; and
transmit the audio data via the new communication linkage.

14. The computer program product of claim 12, wherein the processing device is further configured to:
query one or more repositories based on the network communication data and retrieve and store query results;
access and retrieve the reference network communication matrix; and
generate, using the AI engine, a network communication transmission template based on the reference network communication matrix and the query results, wherein the AI engine comprises a large language model.

15. The computer program product of claim 12, wherein the network transmission enrichment protocol comprises:
accessing and evaluating, using the AI engine, the one or more network communication transmissions to determine communication transmission attributes, wherein the AI engine further comprises a convolutional neural network; converting the one or more network communication transmissions to an alternate data type; and
extracting, using the AI engine, metadata associated with the one or more network communication transmissions based on the alternate data type.

16. A computer-implemented method for real time networked communication monitoring, remediation, and alerting using generative technologies:
initiating a communication linkage with one or more network communication channels;
compiling and extracting one or more network communication transmissions associated with a network anomaly from the one or more network communication channels;
executing, using an artificial intelligence (AI) engine, a network transmission enrichment protocol based on the one or more network communication transmissions;
extracting, using the AI engine, network communication data based on the network transmission enrichment protocol;
mapping, using the AI engine, the network communication data to a reference network communication matrix; and
initiating, using the AI engine, one or more network anomalies remediations associated with the network anomaly.

17. The computer-implemented method of claim 16, wherein computer-implemented method further comprises:
monitoring, via a robotic process automation (RPA) bot, the one or more network communication channels for a device communication linkage;
compiling, using the RPA bot, audio data via the device communication linkage;
detecting, using the RPA bot, at least one disrupted device communication linkage associated with the one or more network communication channels;
establishing, using the RPA bot, a new device communication linkage;
confirming, using the RPA bot, successful connection between the new communication linkage and the one or more network communication channels; and
transmitting the audio data via the new communication linkage.

18. The computer-implemented method of claim 16, wherein computer-implemented method further comprises:
querying one or more repositories based on the network communication data and retrieve and store query results;
accessing and retrieving the reference network communication matrix; and
generating, using the AI engine, a network communication transmission template based on the reference network communication matrix and the query results, wherein the AI engine comprises a large language model.

19. The computer-implemented method of claim 16, wherein the network transmission enrichment protocol comprises:
accessing and evaluating, using the AI engine, the one or more network communication transmissions to determine communication transmission attributes, wherein the AI engine further comprises a convolutional neural network; converting the one or more network communication transmissions to an alternate data type; and
extracting, using the AI engine, metadata associated with the one or more network communication transmissions based on the alternate data type.

20. The computer-implemented method of claim 16, wherein computer-implemented method further comprises:
determining, using the AI engine, one or more missing criteria from one or more systems of record;
determining and executing one or more authentication methods to connect to the communication linkage; and
receiving the one or more missing criteria via the communication linkage.
